(19) United States
(12) Patent Application Publication
(10) Pub. No.: US 2026/0138889 A1
(43) Pub. Date: May 21, 2026

(54) WATER FILTER AND HOME APPLIANCE HAVING SAME

(71) Applicant: LG ELECTRONICS INC., Seoul (KR)

(72) Inventors: Jongpil KIM, Seoul (KR); Seonghee LIM, Seoul (KR)

(21) Appl. No.: 19/348,032

(22) Filed: Oct. 2, 2025

(30) Foreign Application Priority Data
Nov. 15, 2024 (KR) 10-2024-0163469

(51) Int. Cl. C02F 1/00; F25D 23/00

(52) U.S. Cl. CPC C02F 1/003; F25D 23/00; C02F 2201/004; C02F 2307/12; F25D 2323/121; F25D 2700/00

(57) ABSTRACT

The present disclosure relates to water filter and a home appliance having the water filter, the water filter detachably coupled to a head connected to a water supply source comprises a housing having an upper opening formed at an upper portion thereof, and configured to be coupled to the head by rotation; a filter cover provided inside the housing to cover the upper opening and including a water inlet part protruding upward through which water flows in, and a water outlet part through which water flows out; and a filter member disposed inside the housing and connected to the filter cover to purify water, wherein the filter cover includes a fixing protrusion protruding upward to be inserted into the head and the fixing protrusion is configured to keep the filter cover fixed state when the housing rotates.

### CROSS-REFERENCE TO RELATED APPLICATIONS

The present application claims the benefits of priority to Korean Patent Application No. 10-2024-0163469, filed on November 15, 2024, of which its incorporated herein by reference in its entirety.

### THE BACKGROUND

The present disclosure relates to water filter and a home appliance having the same.

Generally, the filter device may include a head provided on a flow path through which water flows, and a filter detachably coupled to the head and having a built-in filter member for purification. According to the type of the filter member, the filter device may have various purification performances, and the filter device may be configured by a coupling of a plurality of filters having different types of filter members.

In addition, these filter devices require periodic replacement to maintain water purification performance, and can be configured to have an easy-to-replace structure so that the user can easily replace them at any time desired.

Meanwhile, the filter device may have a structure that is convenient for mounting and separation, and in particular, various structures are being developed in which incorrect mounting is prevented and accurate mounting is induced by the coupled structure of the head and the filter.

In addition, a filter device is being developed that switches the internal flow path of the head by rotating the filter during the process of attaching and detaching the filter to the head, thereby preventing water leakage even when the filter is separated.

However, in such filter devices, there is a problem that the internal flow path structure of the head for switching the flow path is complicated. In addition, if the flow path is switched repeatedly, the durability of the head is reduced, and this causes a problem of water leakage.

### THE SUMMARY

An object of an embodiment of the present disclosure is to provide a water filter and a home appliance equipped with the water filter, which facilitate rotation of the housing during coupling of the water filter.

An object of an embodiment of the present disclosure is to provide a water filter and a home appliance equipped with the water filter, which prevent leakage during attachment and detachment of the water filter.

An object of an embodiment of the present disclosure is to provide a water filter and a home appliance equipped with the water filter, which prevent damage of the water filter in the event of incorrect operation.

As an embodiment of the present disclosure, a water filter detachably coupled to a head connected to a water supply source comprises a housing having an upper opening formed at an upper portion thereof, and configured to be coupled to the head by rotation; a filter cover provided inside the housing to cover the upper opening and including a water inlet part protruding upward through which water flows in, and a water outlet part through which water flows out; and a filter member disposed inside the housing and connected to the filter cover to purify water, wherein the filter cover includes a fixing protrusion protruding upward to be inserted into the head and the fixing protrusion is configured to keep the filter cover fixed state when the housing rotates.

The water inlet part and the water outlet part may protrude from the filter cover at positions spaced apart from each other with respect to a center of the filter cover.

The fixing protrusion may be formed between the water inlet part and water outlet part.

The fixing protrusion may be positioned at an equal distance from the water inlet part and water outlet part.

The fixing protrusion may be disposed between tangents passing through the water inlet part and water outlet part from the center of the filter cover.

The fixing protrusion may comprise a pair of the fixing protrusion, and a width between the pair of fixing protrusions may correspond to an opening size of a fixing groove formed in the head.

The fixing protrusion may be formed with a rounded shape in a direction corresponding to a rotational direction of the housing.

A protrusion may be formed to protrude toward a center of the housing along an opened inner surface of the housing and defines the upper opening, and the filter cover may be mounted below the protrusion such that the water inlet part, the water outlet part, and the fixing protrusion pass through the upper opening.

The fixing protrusion may be formed to extend along the upper opening.

The fixing protrusion may be formed with a curvature corresponding to the upper opening.

The filter cover may include a cover upper surface exposed through the upper opening, and the fixing protrusion may be formed along an edge of the cover upper surface.

The fixing protrusion may be formed such that a thickness thereof becomes thinner as the fixing protrusion extends upward from the filter cover.

The fixing protrusion may include an inner surface facing a center direction of the filter cover and an outer surface facing a direction opposite to the inner surface, and an inclination angle of the inner surface with respect to a vertical extension line from the filter cover may be greater than an inclination angle of the outer surface.

Left and right end portions of the fixing protrusion may be formed to become closer to each other as they extend upward from the filter cover.

An upper end of the fixing protrusion may be formed to be parallel with an upper surface of the filter cover, and rounded portions may be formed on left and right sides of the fixing protrusion, the rounded portions being connected to the left and right end portions and having a rounded shape.

The fixing protrusion may be formed to have a height lower than that of the water inlet part and the water outlet part, and when the filter may be coupled to the head, the fixing protrusion and the water inlet part and water outlet part are sequentially inserted into the head.

The water inlet part and the water outlet part may be disposed on a horizontal extension line passing through a center of the filter cover, and the fixing protrusion may be disposed on a vertical extension line passing through the center of the filter cover and intersecting the horizontal extension line perpendicularly.

A sensing member for recognizing the filter may protrude upward from the filter cover, and the sensing member may be recognized by a filter sensing device provided in the head when the filter is coupled.

The fixing protrusion may be formed to be lower than the water inlet part and the water outlet part, and higher than the sensing member.

As an embodiment of the present disclosure, a appliance comprising: a cabinet; a head disposed in the cabinet and connected to a water supply source; and a water filter detachably coupled to the head, wherein the water filter comprises: a housing having an upper opening formed therein and configured to be coupled to the head by rotation; a filter cover provided inside the housing to cover the upper opening, and including a water inlet part protruding upward through which water is introduced and a water outlet part through which water is discharged; and a filter member provided inside the housing and connected to the filter cover for purifying water, wherein the filter cover includes a fixing protrusion protruding upward to be inserted into the head and the fixing protrusion is configured to keep the filter cover fixed state when the housing rotates.

### BRIEF DESCRIPTION OF THE DRAWINGS

FIG. 1 is a view illustrating a flow path structure for water supply of a refrigerator according to a first embodiment of the present disclosure.

FIG. 2 is an exploded perspective view showing the filter of the filter assembly separated from the head according to a first embodiment of the present disclosure.

FIG. 3 is an exploded perspective view of the head.

FIG. 4 is a cross-sectional view taken along line 4-4 of FIG. 2.

FIG. 5 is an exploded perspective view of a valve, which is a component of the head.

FIG. 6 is a bottom view of the head.

FIG. 7 is a perspective view of the head inner member.

FIG. 8 is a cross-sectional view taken along line 8-8 of FIG. 7.

FIG. 9 is an exploded perspective view of the filter.

FIG. 10 is a side view of the upper portion of the filter as seen from one side.

FIG. 11 is a side view of the upper portion of the filter as seen from the opposite side.

FIG. 12 is a cutaway perspective view taken along line 12-12 of FIG. 9.

FIG. 13 is a perspective view of the filter cover of the filter as seen from above.

FIG. 14 is a side view of the filter cover.

FIG. 15 is a top view of the filter cover.

FIG. 16 is a cutaway perspective view taken along line 16-16 of FIG. 13.

FIG. 17 is a cutaway perspective view taken along line 17-17 of FIG. 13.

FIG. 18 is a longitudinal sectional view showing the state in which the upper housing and the filter cover are coupled.

FIG. 19 is a view illustrating the state of the fixing protrusion and the fixing groove according to rotation of the housing.

FIG. 20 is an exploded perspective view showing the state in which the filter and the head are separated for coupling of the filter.

FIG. 21 is a cross-sectional view taken along line 21-21 of FIG. 20.

FIG. 22 is a view showing the coupling structure of the guide protrusion and the guide portion when the filter is coupled to the head.

FIG. 23 is a longitudinal sectional view showing the arrangement of the water inlet and the water outlet while the filter is being coupled to the head.

FIG. 24 is a longitudinal sectional view showing the arrangement of the fixing protrusion while the filter is being coupled to the head.

FIG. 25 is a longitudinal sectional view showing the arrangement of the water inlet and the water outlet when the filter is completely coupled to the head.

FIG. 26 is a longitudinal sectional view showing the arrangement of the fixing protrusion when the filter is completely coupled to the head.

FIG. 27 is a view illustrating water flow when the filter is completely coupled to the head.

FIG. 28 is a perspective view of the filter cover according to a second embodiment of the present disclosure.

FIG. 29 is a perspective view of the filter cover according to a third embodiment of the present disclosure.

FIG. 30 is a longitudinal sectional view showing the state in which the filter and the head are being coupled according to the third embodiment of the present disclosure.

FIG. 31 is a longitudinal sectional view showing the state in which the coupling of the filter and the head is completed.

### DETAILED DESCRIPTION

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

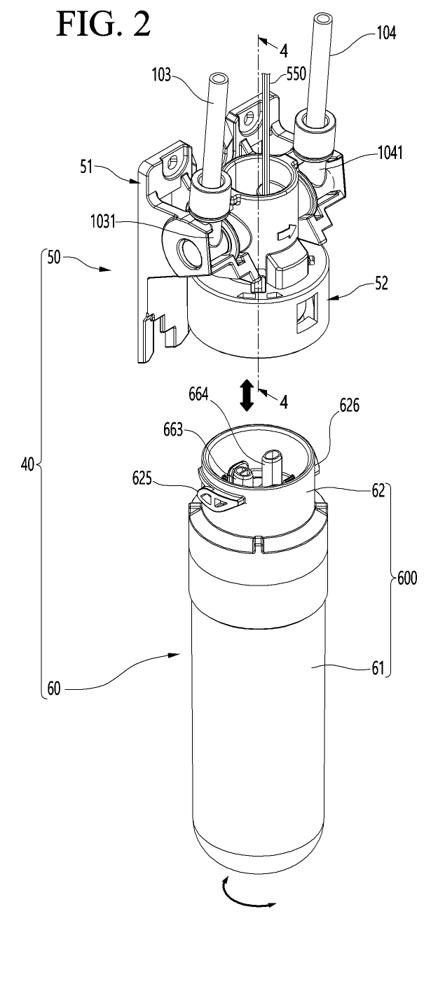

Before the explanation, the direction is defined. In the embodiment of the present disclosure, the direction toward the head in FIG. 2 may be referred to as an upper direction, the direction toward the filter may be referred to as a lower direction, the direction toward the mounting member may be referred to as a rear direction, and the direction away from the mounting member may be referred to as a front direction. In addition, the direction toward the center of the filter and the head may be referred to as an inner direction, and the direction away from the center may be referred to as an outer direction.

In addition, although the embodiment of the present disclosure has been described using a refrigerator as an example among many home appliances, it should be noted in advance that the filter according to the embodiment of the present disclosure can be applied to various home appliances requiring purified water, such as water purifiers and ice makers, without being limited in structure and shape.

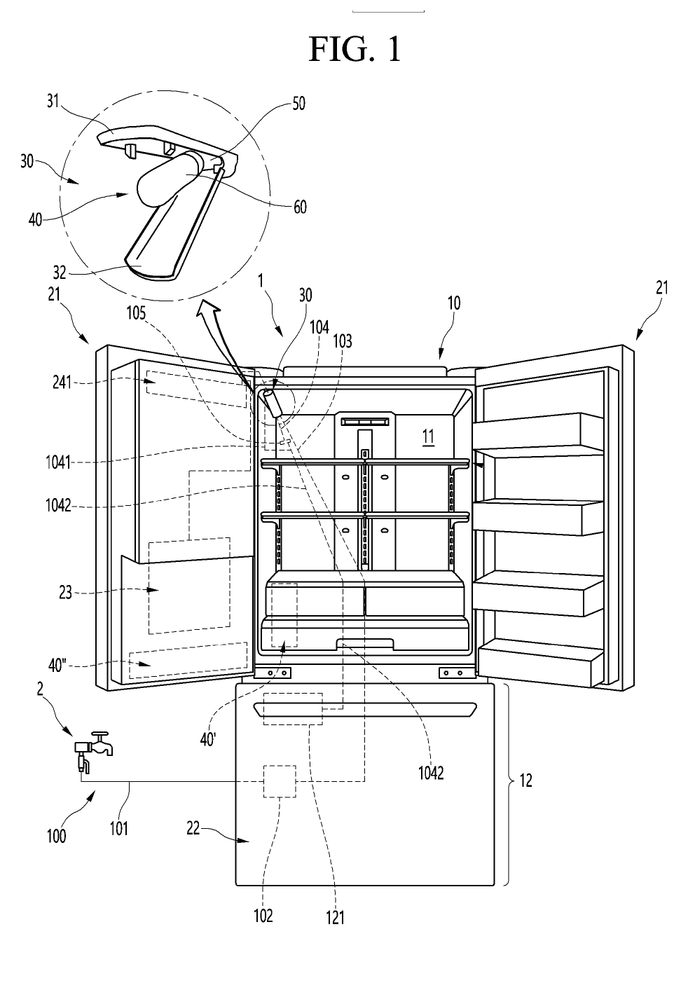

FIG. 1 is a view illustrating a flow path structure for water supply of a refrigerator according to a first embodiment of the present disclosure.

As illustrated, a refrigerator 1 according to an embodiment of the present disclosure may have an outer appearance formed by a cabinet 10 forming a storage space and a door 20 for opening and closing the storage space of the cabinet 10.

The storage space may include a refrigerating compartment 11 positioned at the upper part of the cabinet 10 and a freezing compartment 12 positioned at the lower part of the cabinet 10.

The door 20 may include a refrigerating compartment door 21 and a freezing chamber door 22 that independently open and close the refrigerating compartment 12 and freezing compartment 13, respectively. The refrigerating compartment doors 21 may be provided in pairs on the left and right sides, and may be configured to open and close the refrigerating compartment 11 by rotation. In addition, the freezing chamber door 22 may have a structure like a drawer and may be configured to open and close the freezing compartment 12 by being pulled in and out.

According to the disposition of the storage space and the type and shape of the refrigerator that opens and closes the storage space, an embodiment of the present disclosure may have various structures, and for convenience of explanation and understanding, the embodiment of the present disclosure will be described based on a refrigerator in which the refrigerating compartment is disposed above the freezing compartment and is opened and closed by a pair of doors.

A dispenser 23 and an ice maker 241 may be provided on one of the pair of refrigerating compartment doors 21. The ice maker 241 may be provided inside the refrigerating compartment 11 or in the freezing compartment 12 rather than on the refrigerator door.

The dispenser 23 is provided on the front surface of the refrigerating compartment door 21 and can be configured to allow a user to operate it from the outside to dispense water or ice. In addition, an ice making compartment 24 is provided above the dispenser 23. The ice making compartment 24 is an insulated space where ice is made and stored, and the ice maker 241 is accommodated inside thereof and can be configured to be opened and closed by a separate door.

In addition, an ice maker 121 may be provided inside the freezing compartment 12. the ice maker 241 provided in the refrigerating compartment 11 may be referred to as a first ice maker 241, and the ice maker 121 provided in the freezing compartment 12 may be referred to as a second ice maker 121.

The refrigerator 1 may be equipped with a filter assembly 40 for purifying water supplied from an external water supply source 2. For example, the water supply source 2 may be a tap water source. In addition, the water supply source 2 may be a container storing water, such as a water tank. the water tank may be provided inside or outside of the refrigerator 1.

The filter assembly 40 can be connected to a water device that uses purified water. The water device can include an ice maker that makes ice, a dispenser that dispenses purified water, or the like. In addition, the water device and filter assembly 40 can be used in other home appliances such as a water purifier rather than a refrigerator.

For example, water supplied from the water supply source 2 may be purified by the filter assembly 40 and then dispensed to the dispenser 23 or supplied to the ice maker 241, 121. In addition, the water supply source 2, the filter assembly 40, the dispenser 23, and the ice maker 241, 121 may be connected by a water supply flow path 100.

In detail, the water supply flow path 100 may include a connection pipe 101 connected to the water supply source 2 and a water supply valve 102 inside the cabinet 10. The water supply flow path 100 may include a water inlet pipe 103 and a water outlet pipe 104. The water inlet pipe 103 may be configured to connect the water supply valve 102 and the filter assembly 40 to supply water to the filter assembly 40. The water outlet pipe 104 may be connected to the filter assembly 40 and the dispenser 23 or the ice maker 241, 121 to supply purified water.

In addition, the water outlet pipe 104 may be branched by a branch valve 105. For example, the water outlet pipe 104 may include a first water outlet pipe 1041 that supplies purified water to the dispenser 23 and the first ice maker 141, and a second water outlet pipe 1042 that supplies purified water to the second ice maker 121.

the filter assembly 40 may be provided in the refrigerating compartment 11. For example, the filter assembly 40 may be provided at a corner of one of the left and right sides of the upper surface of the refrigerating compartment 11. As another example, the filter assembly 40' may be provided between storage members such as drawers or shelves of the refrigerating compartment 11 or at a rear part covered by the storage members. As another example, the filter assembly 40'' may be provided in the refrigerating compartment door 21.

Meanwhile, the filter assembly 40 may be configured to facilitate replacement of the filter 60, in which actual water purification is performed. As one example, a filter device 30 may be provided in the refrigerator compartment 11. The filter device 30 may include a case 31 mounted to the cabinet 10, a cover 32 configured to open and close the case 31, and the filter assembly 40 installed inside the case 31 so as to be exposed when the cover 32 is opened.

The filter assembly 40 may include a filter 60 and a head 50. When the cover 32 is opened, the filter 60 may be exposed forward, allowing easy attachment and detachment. The filter 60 is for water purification and may be referred to as a water filter or simply a filter.

Below, the structure of the filter assembly 40 is described in more detail with reference to the drawings.

FIG. 2 is an exploded perspective view showing the filter of the filter assembly separated from the head according to a first embodiment of the present disclosure.

As illustrated, the filter assembly 40 may include a head 50 for mounting the filter assembly 40 and a filter 60 detachably mounted on the head 50.

For example, the head 50 may include a mounting member 51 and a head body 52. The mounting member 51 is for mounting the filter assembly 40, and a fixing member such as a screw may be fastened to fix the filter assembly 40 to a target location. For example, the mounting member 51 may be fixed to one side of the refrigerating compartment 11. Meanwhile, when a structure for mounting the head 50 is provided in the refrigerator 1, the mounting member 51 may be omitted.

The head body 52 can be rotated with respect to the mounting member 51 while the filter 60 is mounted, thereby making it easier to attach or detach the filter 60.

The water inlet pipe 103 and the water outlet pipe 104 may be connected to both sides of the head body 52. The water inlet pipe 103 and the water outlet pipe 104 may be connected to the head body 52 by a water inlet pipe fitting 1031 and a water outlet pipe fitting 1041, respectively. Accordingly, water flowing in through the water inlet pipe fitting 1031 from the water inlet pipe 103 may pass through the head body 52 and be supplied to the filter 60, and water purified in the filter 60 may pass through the head body 52 and be discharged to the water outlet pipe 104 through the water outlet pipe fitting 1041.

The filter 60 may include a housing 600 that forms its exterior. The housing 600 may be detachably mounted to the head body 52. The housing 600 may have its outer shape defined by an upper housing 62 and a lower housing 61. The housing 600 may further include a filter cover 66, which closes the opening of the upper housing 62 and is provided with a water inlet part 663 and a water outlet part 664.

In addition, guide protrusions 625 and 626 for coupling with the head 50 may be formed on the outer surface of the upper housing 62. The upper housing 62 may be inserted through the open bottom surface of the head body 52, and the guide protrusions 625 and 626 may rotate along the inner surface of the head body 52 and move into position to be coupled to the head body 52.

In this process, the housing 600 rotates relative to the head 50, while the water inlet part 663 and the water outlet part 664 remain in a fixed, non-rotating state and move upward to communicate with the flow path inside the head 50. Accordingly, water supplied through the inlet pipe 103 may be purified by passing through the filter 60 and then discharged through the outlet pipe 104.

Below, the head 50 will be described in more detail with reference to the drawings.

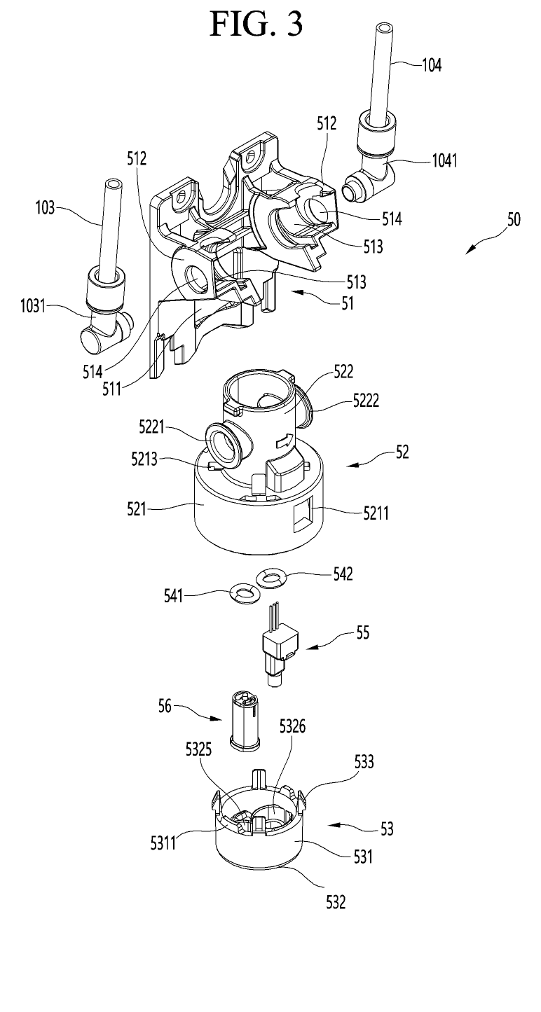

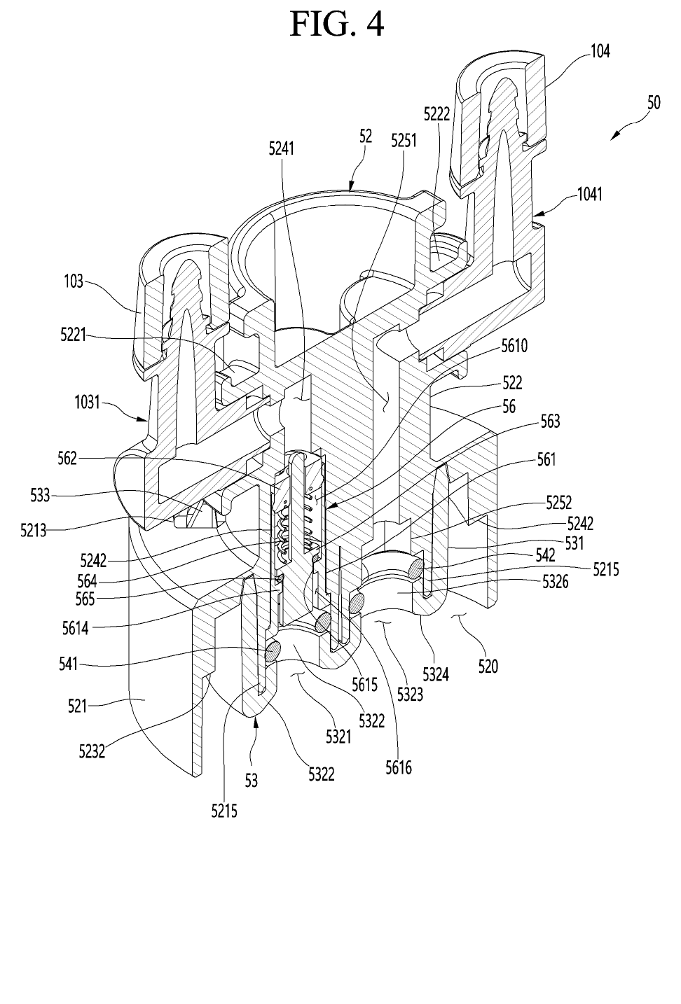

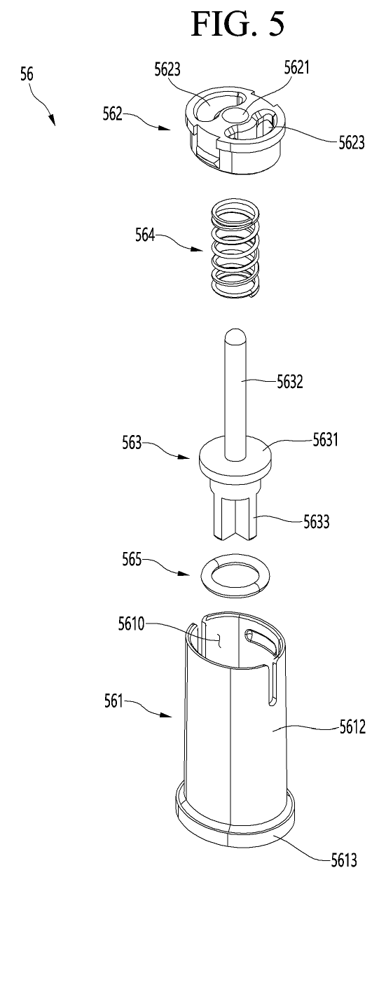

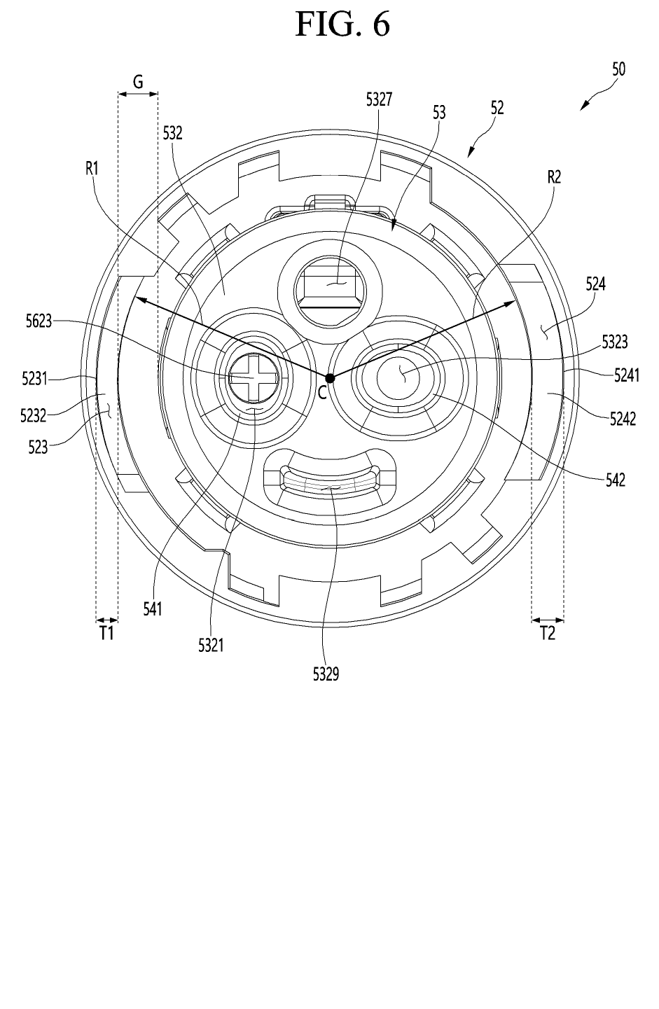

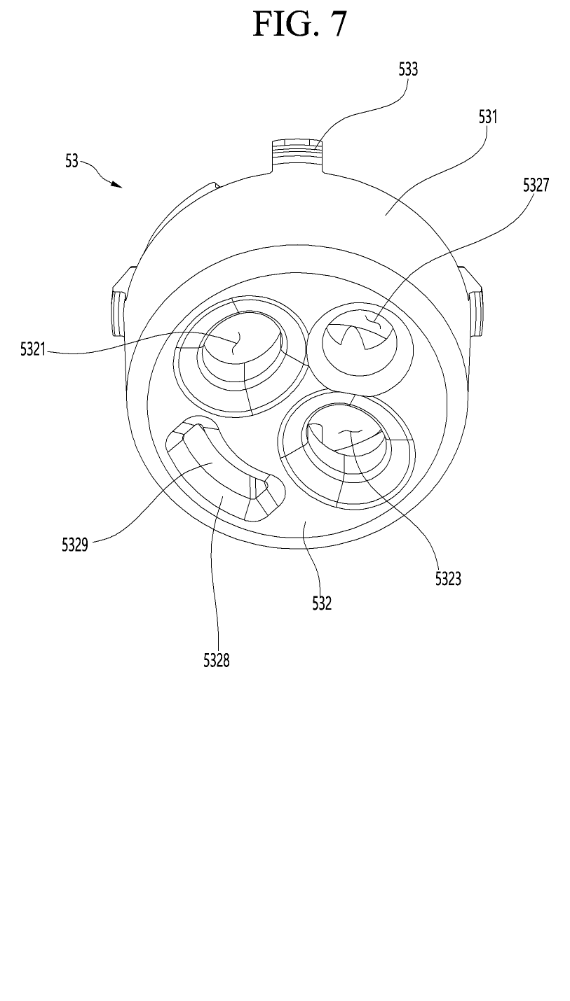

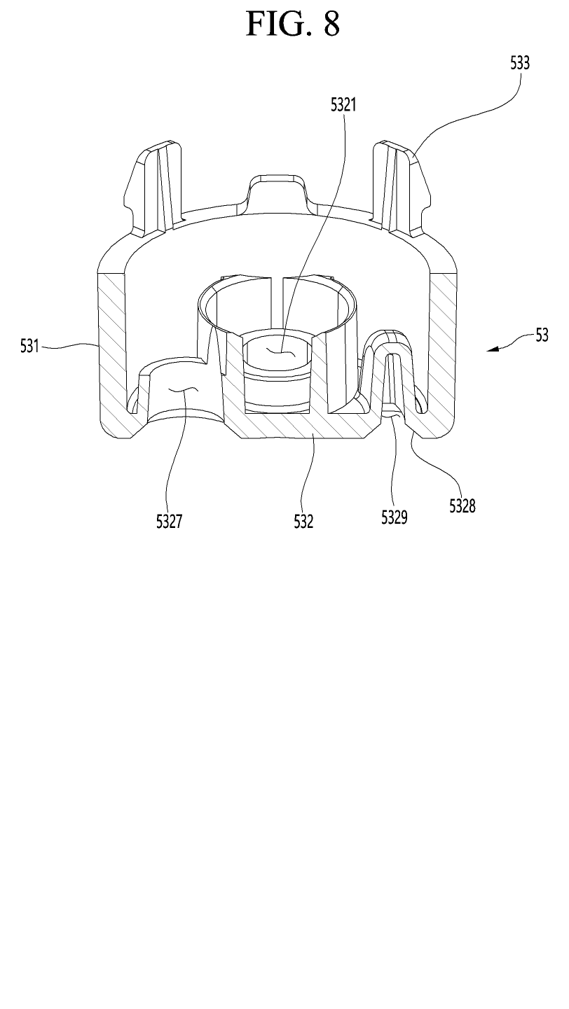

FIG. 3 is an exploded perspective view of the head, and FIG. 4 is a cross-sectional view taken along line 4-4 of FIG. 2, and FIG. 5 is an exploded perspective view of a valve, which is a component of the head, and FIG. 6 is a bottom view of the head, and FIG. 7 is a perspective view of the head inner member, and FIG. 8 is a cross-sectional view taken along line 8-8 of FIG. 7.

As illustrated, the head 50 may include a head body 52, the inlet pipe 103, and the outlet pipe 104. The head 50 may further include a mounting member 51.

The mounting member 51 may include a mounting portion 511 that comes into contact with a mounting target such as the cabinet 10, and a head connecting portion 512 to which the head body 52 is rotatably coupled.

A screw may be fastened to the mounting portion 511, thereby allowing the head 50, or the head 50 with the filter 60 mounted, to be securely fixed in place.

The head connecting portions 512 may be formed on both left and right sides of the mounting portion 511, and the head body 52 may be disposed between the pair of head connecting portions 512. A fitting seating part 513, on which fittings 1031 and 1041 are seated, may be formed in the head connecting portions 512. In addition, a seating part opening 514, into which the fittings 1031 and 1041 are axially coupled, may be formed on the side surface of the fitting seating part 513.

The water inlet pipe fitting 1031 and the water outlet pipe fitting 1041 are respectively seated in the fitting mounting parts 513 located on both sides, and can be rotatably disposed by being axially coupled to the seating part openings 514. In addition, the water inlet pipe fitting 1031 and the water outlet pipe fitting 1041 can be rotatably connected to both sides of the head body 52.

the head body 52 may include a head upper 522 and a head lower 521. The head upper 522 may be connected to the water inlet pipe fitting 1031 and the water outlet pipe fitting 1041. A water inlet pipe connection part 5221 connected to the water inlet pipe fitting 1031 and a water outlet pipe connection part 5222 connected to the water outlet pipe fitting 1041 may be provided on both sides of the head upper 522.

The head lower portion 521 may be formed at a lower side of the head upper 522. The head lower 521 may have an open bottom surface to form a coupling space 520 into which the upper end of the filter 60 is coupled. In addition, a check window 5211 may be formed at the center of the front surface of the head lower portion 521 so that the correct mounting state of the filter 60 can be visually confirmed.

In addition, coupling guides 523 and 524 may be formed on the inner surface of the head lower 521 to guide insertion and coupling of the filter 60. As one example, the coupling guides 523 and 524 may include a first guide 523 and a second guide 524. The first guide 523 may be configured to guide insertion and coupling of a first guide protrusion 625 formed on the filter 60, and the second guide 524 may be configured to guide insertion and coupling of a second guide protrusion 626 formed on the filter 60.

The first guide 523 may be recessed into the inner surface of the head lower 521 and extend upward from the lower end of the head lower 521. The first guide 523 may extend up to the check window 5211 so as to guide the first guide protrusion 625 to move along the first guide 523 toward the check window 5211.

The first guide 523 may include a first guide hole 5231, which is opened at the lower end of the head lower 521 and into which the first guide protrusion 625 is inserted. The first guide 523 may further include a first guide portion 5232 extending from one end of the first guide hole 5231 toward the check window 5211.

The first guide portion 5232 may be formed along the circumference of the inner surface of the head lower 521. The first guide portion 5232 may be formed in an inclined or rounded shape. The first guide protrusion 625, inserted into the first guide hole 5231, may move toward the check window 5211 while coming into contact with the first guide portion 5232.

The second guide 524 may be formed at a position facing the first guide 523. In addition, the second guide 524 may be formed in a shape corresponding to the first guide 523, but may be formed to extend in a direction opposite to the extension direction of the second guide 524.

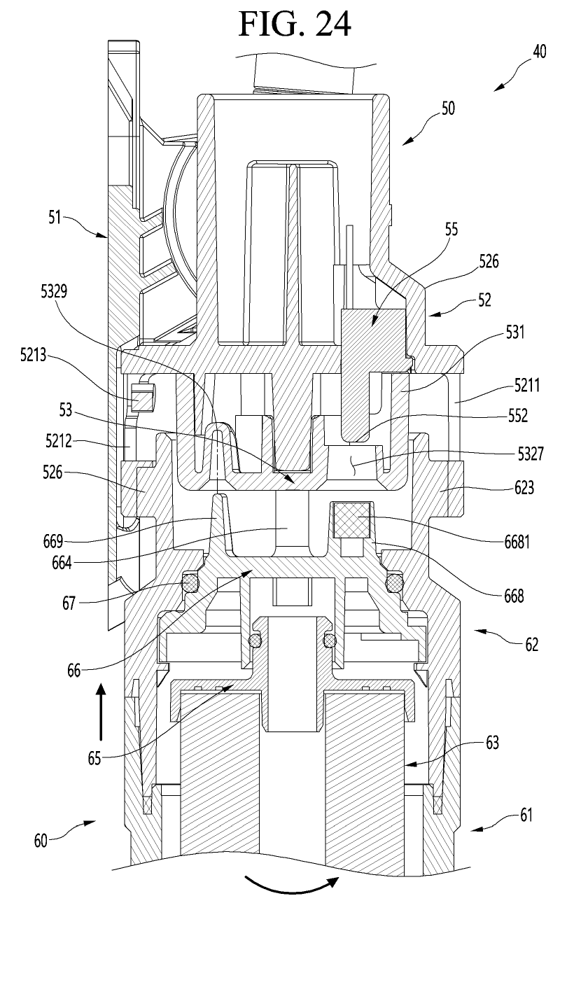

The second guide 524 may include a second guide hole 5241, which is opened at the lower end of the head lower 521 and into which the second guide protrusion 626 is inserted. The second guide hole 5241 may be formed in a direction facing the first guide hole 5231. The second guide 524 may further include a second guide portion 5242 extending from one end of the second guide hole 5241 toward the center of the rear surface of the head lower 521, that is, toward the rear check window 5212 (shown in FIG. 24).

The second guide portion 5242 may be formed along the circumference of the inner surface of the head lower 521 in an inclined or rounded shape and may come into contact with the second guide protrusion 626. The second guide protrusion 626, inserted into the second guide hole 5241, may move while coming into contact with the second guide portion 5242.

Accordingly, the filter housing 600 may be rotated while the first guide protrusion 625 and the second guide protrusion 626 move along the first guide hole 5231 and the second guide hole 5241.

Meanwhile, a head inner 53 may be coupled inside the head body 52. The head inner 53 may be exposed through the open bottom surface of the head body 52. The head inner 53 may be formed with an inlet hole 5321 and an outlet hole 5323 into which the water inlet part 663 and the water outlet part 664 are inserted. In addition, the head inner 53 may be provided with an inlet ring 541 and an outlet ring 542 for sealing the water inlet part 663 and the water outlet part 664.

The head inner 53 may be formed with a sensing hole 5327 into which a sensing member 668is inserted. A filter sensing device 55 for detecting the filter 60 may be mounted above the sensing hole 5327. In addition, the head inner 53 may be formed with a fixing groove 5329 into which a fixing protrusion 669 is inserted, so as to facilitate relative rotation of the housing 600.

In detail, the head inner 53 may be formed in a circular shape and may include an inner base 532 forming a bottom surface, and an inner wall 531 extending upward along the circumference of the inner base 532.

The inner base 532 may be formed with the inlet hole 5321 and the outlet hole 5323. The inlet hole 5321 and the outlet hole 5323 may each be formed in an elliptical shape corresponding to the cross-sectional shapes of the water inlet part 663 and the water outlet part 664, respectively. When the first guide protrusion 625 and the second guide protrusion 626 are inserted into and mounted in the first guide hole 5231 and the second guide hole 5241, the water inlet part 663 and the water outlet part 664 may naturally be inserted into the inlet hole 5321 and the outlet hole 5323, respectively. In addition, the inlet hole 5321 and the outlet hole 5323 may be arranged with orientation so as to prevent incorrect installation of the filter 60.

As one example, as illustrated in FIG. 6, the inlet hole 5321 may be formed such that its major axis is arranged in the front-rear direction, and the outlet hole 5323 may be formed such that its major axis is arranged in the left-right direction.

An inlet rim 5325 extending upward may be formed around the inlet hole 5321. The upper end of the inlet rim 5325 may support the inlet ring 541 so that the inlet ring 541 is seated thereon. In addition, an outlet rim 5326 extending upward may be formed around the outlet hole 5323. The upper end of the outlet rim 5326 may support the outlet ring 542 so that the outlet ring 542 is seated thereon. The inlet ring 541 and the outlet ring 542 may each be formed in an elliptical shape that comes into contact with the outer surfaces of the water inlet part 663 and the water outlet part 664, thereby ensuring airtight sealing.

Meanwhile, a filter sensing device 55 for detecting the installation of the filter 60 may be provided inside the head body 52. As one example, the filter sensing device 55 may be a sensor that detects a change in a magnetic field. As another example, the filter sensing device 55 may be implemented as a proximity sensor, a contact switch, or an RFID reader. A wire 550 connected to the filter sensing device 55 may extend upward from the head body 52.

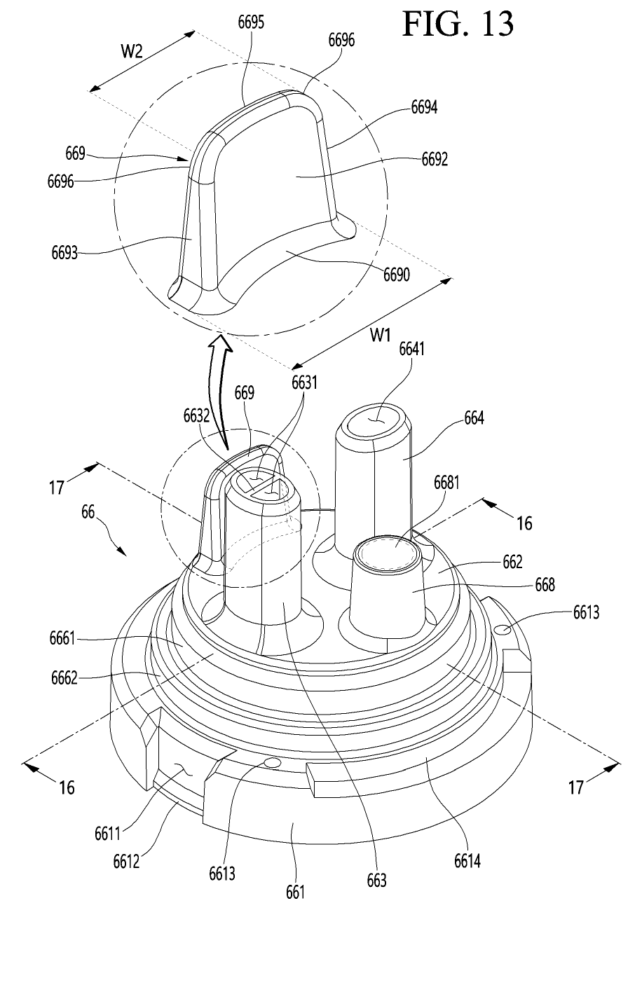

The inner base 532 may be formed with a sensing hole 5237 into which a sensing member 668 (in FIG. 13) described below, is inserted. The filter sensing device 55 may be provided above the sensing hole 5237. Accordingly, when the filter 60 is mounted to the head 50, the sensing member 668may be inserted into the sensing hole 5237, and the filter sensing device 55 may detect the sensing member 668to determine whether the filter 60 is installed.

The inner base 532 may be formed with a fixing groove 5329 into which the fixing protrusion 669 is inserted. The fixing groove 5329 may be recessed in a shape corresponding to the fixing protrusion 669 so that the fixing protrusion 669 (in FIG. 13) can be closely fitted therein.

An inclined portion 5328 may be formed around the circumference of the open bottom surface of the fixing groove 5329. The inclined portion 5328 may be inclined upward toward the inner side of the fixing groove 5329. Accordingly, the inclined portion 5328 may guide insertion of the fixing protrusion 669, and during attachment and detachment of the filter 60, may allow the fixing protrusion 669 to enter and exit the fixing groove 5329 without being caught, thereby facilitating smooth engagement and disengagement.

The inner surface of the fixing groove 5329 may have a shape that becomes narrower toward the upper side. Accordingly, the fixing groove 5329 may come into close contact with the entire outer surface of the fixing protrusion 669, thereby securely fixing the filter cover 66 during rotation of the housing 600.

An inner coupling portion 533 may protrude upward from the upper end of the inner wall 531. The inner coupling portion 533 may be coupled to a coupling hole 5213 of the head lower 521.

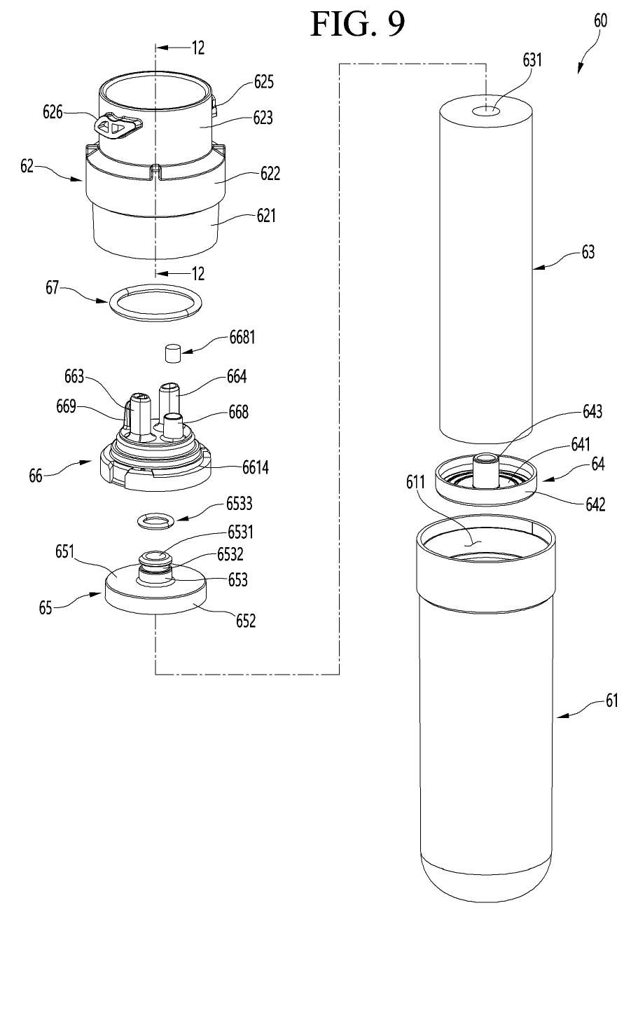

The outer surface of the inner wall 531 may be spaced apart from the inner surface of the head body 52. In this case, the thickness T1 of the first guide portion 5232 may be formed thinner than the thickness T2 of the second guide portion 5242. Accordingly, a gap G between the outer end of the first guide portion 5232 and the outer surface of the inner wall 531 may be formed so that a protrusion extension 6256 of the first guide protrusion 625 (in FIG. 9) can be inserted therein.

In contrast, a gap between the outer end of the second guide portion 5242 and the outer surface of the inner wall 531 may be narrower than the thickness of the protrusion extension 6256, thereby preventing insertion of the protrusion extension 6256.

That is, only the first guide protrusion 625 and the second guide protrusion 626, which respectively correspond to the first guide 523 and the second guide 524, can be inserted into them. In addition, the water inlet part 663 and the water outlet part 664 may also be inserted into the inlet hole 5321 and the outlet hole 5323, respectively, which have corresponding cross-sectional shapes.

In addition, the water inlet part 663 and the water outlet part 664 may be inserted through the inlet ring 541 and the outlet ring 542, which are disposed inside the inlet hole 5321 and the outlet hole 5323, respectively, thereby preventing leakage between the head 50 and the filter 60.

A flow path communicating with the inlet pipe 103, the outlet pipe 104, and the water inlet part 663 and the water outlet part 664 may be formed inside the head body 52. Specifically, an inlet flow path 5241 communicating with the inlet pipe connection 5221 may be formed inside the head body 52, and an outlet flow path 5251 communicating with the outlet pipe connection 5222 may be formed therein.

In addition, a valve mounting portion 5242 connected to the inlet flow path 5241 and configured to receive a valve 56 may be formed inside the head body 52. The valve 56 may be provided above the inlet ring 541. The valve 56 may selectively supply water, fed from the inlet flow path 5241, toward the filter 60, and may be opened and closed depending on whether the filter 60 is installed.

The valve 56 may include a valve case 561, a piston 563, a spring 564, and a valve cap 562.

The valve case 561 may have open upper and lower surfaces and may be formed with a piston receiving portion 5610 inside. A circumferential surface 5612 of the valve case 561 may come into contact with an inner surface of the valve mounting portion 5242. In addition, a piston support 5614 protruding inward may be formed inside the valve case 561.

The piston 563 may be disposed above the piston support 5614 and may move vertically to open and close a case passage 5615. A valve cap 562 may be provided on an upper surface 5611 of the valve case 561. A spring 564 may be disposed between the valve cap 562 and the piston 563 to elastically support the piston 563.

The piston 563 may include a seat portion 5631 that closes the case passage 5615, a contact portion 5633 that protrudes downward from a lower surface of the seat portion 5631 and passes through the case passage 5615, and a rod 5632 that protrudes upward from an upper surface of the seat portion 5631 and passes through the valve cap 562.

The seat portion 5631 may open and close the case passage 5615. When the case passage 5615 is opened by upward movement of the piston 563, water may be supplied toward the water inlet part 663.

Meanwhile, the contact portion 5633 may protrude downward through the case passage 5615 and may come into contact with an upper end of the water inlet part 663 when the filter 60 is installed. A piston ring 565 may be provided at an upper end of the contact portion 5633, i.e., on a lower surface of the seat portion 5631. The piston ring 565 may contact the circumference of the case passage 5615 to seal between the case passage 5615 and the piston 563.

The rod 5632 may extend upward from the center of the seat portion 5631 and may pass through a rod hole 5621 of the valve cap 562. An upper end and a lower end of the spring 564 may be supported by the valve cap 562 and the seat portion 5631, respectively.

The valve cap 562 may cover the upper surface of the valve case 561. A cap through-hole 5623 penetrating the valve cap 562 may be formed therein. Accordingly, when the case passage 5615 is opened by movement of the piston 563, water supplied to the inlet flow path 5241 may flow through the cap through-hole 5623 and the case passage 5615, pass through the valve 56, and be introduced into the water inlet part 663.

In addition, an outlet receiving portion 5252, into which the water outlet part 664 is inserted, may be formed inside the head body 52 and connected to the outlet flow path 5251.

Hereinafter, the filter 60 will be described in detail with reference to the drawings.

FIG. 9 is an exploded perspective view of the filter.

As illustrated, the filter 60 may include a housing 600 forming an exterior appearance, a filter member 63 disposed inside the housing 600, and a filter cover 66 exposed through an upper surface of the housing 600.

The housing 600 may include an upper housing 62 forming an upper portion of the housing 600 and a lower housing 61 forming a lower portion of the housing 600. The upper housing 62 and the lower housing 61 may be coupled to each other to form a space in which the filter member 63 is accommodated.

The upper housing 62 and the lower housing 61 may form a cylindrical shape in the coupled state, thereby forming the exterior of the filter 60. The upper housing 62 and the lower housing 61 may be made of a plastic material and may be joined to each other by ultrasonic welding or spin welding.

The upper housing 62 may be configured with open upper and lower surfaces, and a space 6200, 620 may be formed inside the upper housing 62 in which the filter cover 66 is rotatably disposed.

As one example, the upper housing 62 may include an upper part 623 inserted into the interior of the head body 52 and a lower part 622 exposed downward from the head body 52. First guide protrusions 625 and second guide protrusions 626 may be formed around the circumference of the upper part 623 so that the filter 60 can be detachably coupled to the head 50.

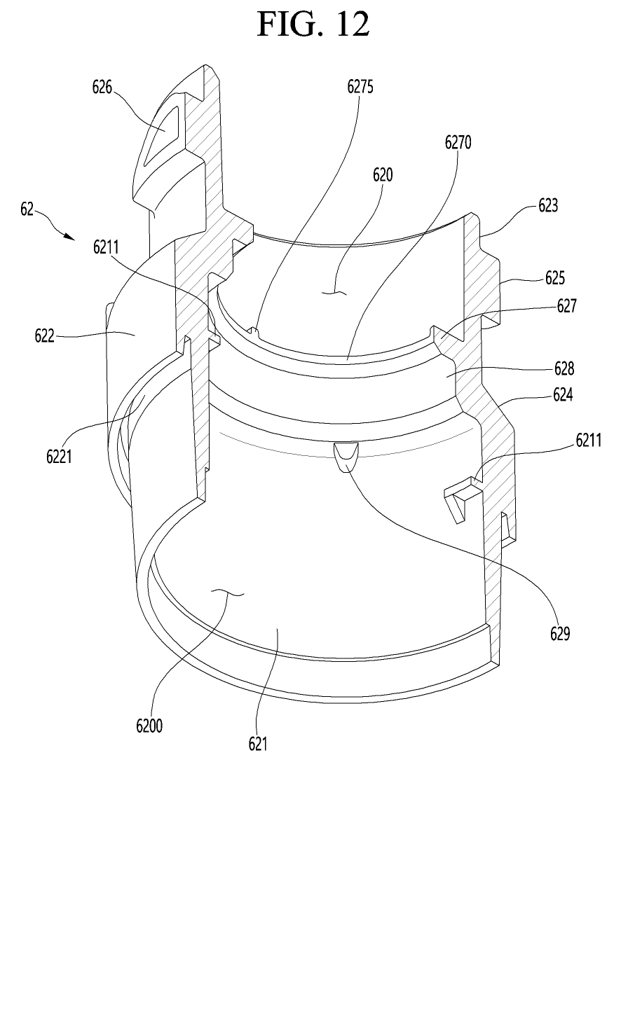

The upper housing 62 may further include a housing coupling portion 621 extending downward beyond the lower part 622. A coupling groove 6221, shown in FIG. 12, into which an upper end of the lower housing 61 is inserted, may be formed between a lower end of the lower part 622 and the housing coupling portion 621. The coupling groove 6221 and the upper end of the lower housing 61 may be welded together to achieve coupling.

The lower housing 61 may have an open upper surface and may form an accommodating space 611 in which the filter member 63 is received. The filter member 63 may be inserted through the open upper surface of the lower housing 61 and accommodated inside the accommodating space 611.

Meanwhile, the housing 600 may rotate relative to the filter cover 66. That is, the filter cover 66 may remain in an aligned state for coupling with the head 50, while the housing 600 rotates to be fastened to the head 50.

The filter cover 66 may be connected to the filter member 63 and an upper supporter 65. Accordingly, the housing 600 may also be considered to rotate relative to the filter cover 66 and the filter member 63, which are coupled together.

The filter member 63 may have a cylindrical shape with a hollow portion 631 passing through its center. The filter member 63 may be formed of a porous material so as to purify water passing through it. As one example, water outside the filter member 63 may pass through the filter member 63, flow into the hollow portion 631, and then flow upward through the hollow portion 631 to supply purified water.

The filter member 63 may be made of various materials and types and may be appropriately selected according to the required purification performance. As one example, the filter member 63 may be implemented as various types of filters such as a membrane filter, a pre-carbon filter, or a sediment filter.

A lower supporter 64 may be provided on a lower surface of the filter member 63. The lower supporter 64 may support the filter 60 from below and may come into contact with a lower surface of the lower housing 61.

The lower supporter 64 may include a supporter bottom surface 641, a lower rim 642, and a lower boss 643. The supporter bottom surface 641 may contact the lower surface of the filter member 63 to support the filter member 63. The lower rim 642 may extend upward along the circumference of the supporter bottom surface 641 to support the lower circumferential edge of the filter member 63. The lower boss 643 may protrude upward from the supporter bottom surface 641 and may be inserted into the lower side of the hollow portion 631 to support an inner surface of the filter member 63.

The upper supporter 65 may be disposed at an upper end of the filter member 63 to fix an upper portion of the filter member 63 and simultaneously guide purified water passing through the hollow portion 631 toward the filter cover 66. The upper supporter 65 may also connect the filter member 63 and the filter cover 66 to each other. Accordingly, the filter member 63 and the filter cover 66 may be in a coupled state by the upper supporter 65, and the housing 600 may rotate relative to the filter member 63 and the filter cover 66.

The filter member 63 may be coupled to the upper supporter 65 and the lower supporter 64, and the upper supporter 65 may be coupled to the filter cover 66. Accordingly, the filter cover 66 may remain stationary together with the filter member 63, and only the housing 600 may rotate.

The upper supporter 65 may include a supporter top surface 651, an upper rim 652, a filter nipple 653, and an upper boss 654. The supporter top surface 651 may contact the upper surface of the filter member 63 to support the filter member 63. The upper rim 652 may extend downward along the circumference of the supporter top surface 651 to support the upper circumferential edge of the filter member 63.

In addition, a filter nipple 653 may protrude upward from the center of the supporter top surface 651. An outlet 6531 communicating with the hollow portion 631 may be formed at an upper end of the filter nipple 653. A sealing groove 5632 into which a nipple seal 6533 is mounted may be formed around the circumference of the filter nipple 653. The filter nipple 653 may be configured to be inserted into a nipple receiving portion 665 of the filter cover 66.

The upper boss 654 may protrude downward from the supporter top surface 651 and may be inserted into an upper portion of the hollow portion 631 to support an inner surface of the filter member 63. The upper boss 654 may be in communication with the filter nipple 653. That is, the filter nipple 653, the upper boss 654, and the hollow portion 631 may be arranged on the same axis and communicate with each other to form a flow path through which water purified by the filter member 63 passes.

The filter cover 66 may be located inside the upper housing 62 and may vertically partition the interior of the upper housing 62. The filter cover 66 may be rotatably mounted to the upper housing 62. A sealing member 67 may be provided between the circumference of the filter cover 66 and the upper housing 62. Accordingly, the filter cover 66 may prevent leakage even while being rotatably mounted to the upper housing 62.

Water inlet part 663 and water outlet part 664 may protrude upward from an upper surface of the filter cover 66. The water inlet part 663 and the water outlet part 664 may be exposed through the open upper surface of the upper housing 62. In addition, a fixing protrusion 669, which is inserted into the fixing groove 5329, may protrude upward from the upper surface of the filter cover 66. A sensing member 668may also protrude upward from the upper surface of the filter cover 66, and a magnet 6681 may be mounted inside the sensing member 668.

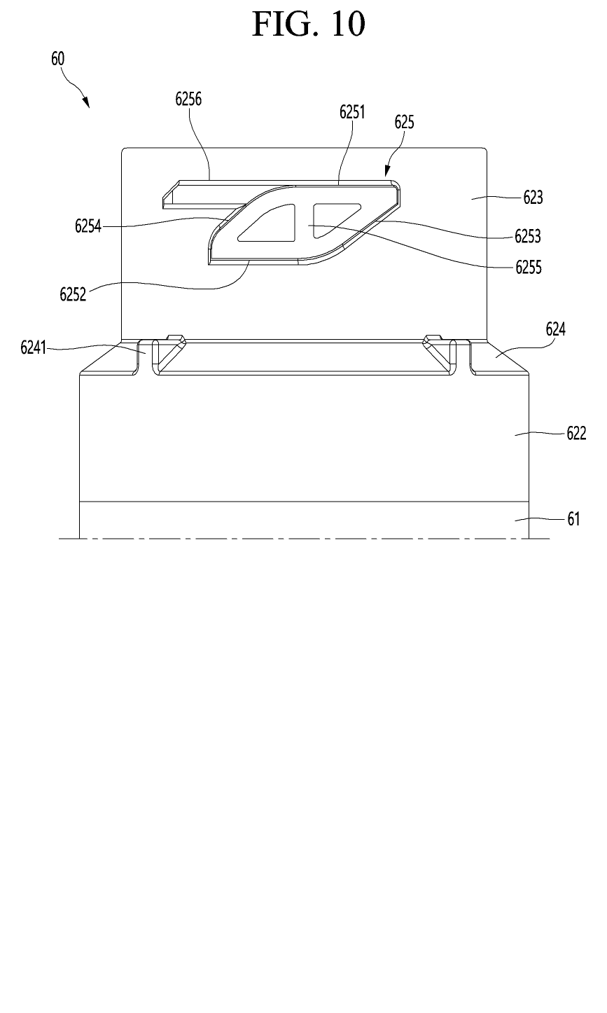

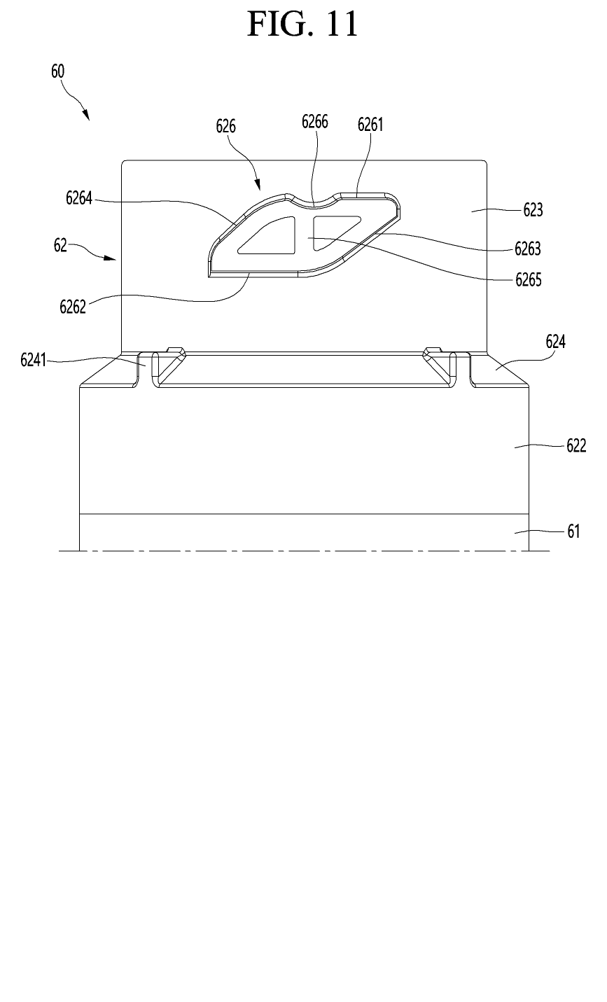

FIG. 10 is a side view of the upper portion of the filter as seen from one side, and FIG. 11 is a side view of the upper portion of the filter as seen from the opposite side, and FIG. 12 is a cutaway perspective view taken along line 12-12 of FIG. 9.

As illustrated, the upper housing 62 may include an upper part 623 and a lower part 622. The upper part 623 may have a smaller diameter than the lower part 622. A connecting surface 624 having a downward slope may be formed between a lower end of the upper part 623 and an upper end of the lower part 622. A housing rib 6241 protruding upward may be formed on the connecting surface 624.

The housing rib 6241 may be positioned adjacent to a lower end of the head body 52 when the filter 60 is installed. Accordingly, the complete fastening of the filter 60 may be visually confirmed through a gap between the housing rib 6241 and the head body 52.

In addition, the housing rib 6241 may serve as a guide for positioning a jig during spin welding of the upper housing 62 and the lower housing 61. A plurality of housing ribs 6241 may be formed along the connecting surface 624, and the housing ribs 6241 may be arranged symmetrically with respect to the center of the upper housing 62.

First guide protrusions 625 and second guide protrusions 626 may protrude from an outer surface of the upper part 623. The first guide protrusions 625 and the second guide protrusions 626 may be formed at positions facing each other with respect to the center of the housing 600. Each first guide protrusion 625 may be formed in a shape insertable into the first guide 523, and each second guide protrusion 626 may be formed in a shape insertable into the second guide 524. The first guide protrusions 625 and the second guide protrusions 626 may have different shapes to prevent incorrect installation of the filter 60 and to guide proper installation.

In particular, the first guide protrusion 625 may come into contact with the first guide 523 and the second guide 524 before the water inlet part 663 and the water outlet part 664 are inserted into the head inner 53. Accordingly, when incorrect installation occurs with respect to the first guide 523, the first guide protrusion 625 may prevent the water inlet part 663 and the water outlet part 664 from coming into contact with the head inner 53, thereby fundamentally preventing deformation or damage of the water inlet part 663 and the water outlet part 664 caused by incorrect installation.

As one example, the first guide protrusion 625 may be formed on the left side with respect to the center of the filter 60. The first guide protrusion 625 may be positioned laterally of the water inlet part 663.

The first guide protrusion 625 may include a first upper portion 6251 forming an upper surface, a first lower portion 6252 forming a lower surface, a first front inclined portion 6253 connecting front ends of the first upper portion 6251 and the first lower portion 6252, and a first rear inclined portion 6254 connecting rear ends of the first upper portion 6251 and the first lower portion 6252. The first upper portion 6251, the first lower portion 6252, the first front inclined portion 6253, and the first rear inclined portion 6254 may protrude from an outer surface of the upper housing 62 with the same thickness. In particular, the first front inclined portion 6253 may be formed to protrude so as to move in a state of contact with the first guide portion 5232, thereby facilitating rotation and upward movement of the filter 60.

The lengths of the first upper portion 6251 and the first lower portion 6252 may be formed to correspond to the size of the first guide hole 5231, so that the first guide protrusion 625 is inserted into the first guide hole 5231 when the filter 60 moves upward. A connecting rib 6255 vertically connecting the first upper portion 6251 and the first lower portion 6252 may further be formed.

Meanwhile, a protrusion extension 6256 extending rearward may be formed at a rear end of the first upper portion 6251. The protruding thickness of the protrusion extension 6256 may be smaller than the protruding thickness of the first upper portion 6251. In addition, the protruding thickness of the protrusion extension 6256 may be smaller than a gap G between the head inner 53 and the first guide portion 5232. Accordingly, when the first guide protrusion 625 is inserted into the first guide hole 5231, the protrusion extension 6256 may be inserted between the first guide portion 5232 and the outer surface of the head inner 53, thereby allowing insertion and rotational movement of the first guide protrusion 625.

The second guide protrusion 626 may include a second upper portion 6261 forming an upper surface, a second lower portion 6262 forming a lower surface, a second front inclined portion 6263 connecting front ends of the second upper portion 6261 and the second lower portion 6262, and a second rear inclined portion 6264 connecting rear ends of the second upper portion 6261 and the second lower portion 6262. The second upper portion 6261, the second lower portion 6262, the second front inclined portion 6263, and the second rear inclined portion 6264 may protrude from the outer surface of the upper part 623 with the same thickness. In particular, the second front inclined portion 6263 may be formed to protrude so as to move in a state of contact with the second guide portion 5242. The protruding thickness of the second guide protrusion 626 may be the same as that of the first guide protrusion 523.

The lengths of the second upper portion 6261 and the second lower portion 6262 may be formed to correspond to the size of the second guide hole 5241 so that the second guide protrusion 626 is inserted into the second guide hole 5241 when the filter 60 moves upward. A connecting rib 6265 vertically connecting the second upper portion 6261 and the second lower portion 6262 may further be formed.

In addition, a restricting groove 6266 recessed downward may be formed in the second upper portion 6261. The restricting groove 6266 may engage with a restricting portion 5213 protruding from the head 50 when the housing 600 is fully rotated, thereby restraining the filter 60.

Meanwhile, a protrusion may be formed inside the upper housing 62. The protrusion may include a first protrusion 627. The protrusion may further include a second protrusion 628. The first protrusion 627 may partition the interior of the upper housing 62 into an upper space 620, in which an upper surface of the filter cover 66 is exposed, and a lower space 6200, in which a lower end of the filter cover 66 is rotatably accommodated.

The first protrusion 627 may be formed on the upper part 623. The first protrusion 627 may protrude toward the center of the upper housing 62 and may form an upper opening 6270 through which the filter cover 66 passes. The first protrusion 627 may support the circumference of the filter cover 66 so that the filter cover 66 is not separated upward even if the pressure inside the filter 60 increases.

A second protrusion 628 may be formed below the first protrusion 627. The second protrusion 628 may be formed in a stepped manner continuously from a lower end of the first protrusion 627. The second protrusion 628 may protrude from an inner surface of the upper housing 62 toward the center of the upper housing 62.

Accordingly, the inner surface of the upper housing 62, the second protrusion 628, and the first protrusion 627 may be sequentially formed in a stepped manner. The stepped shape of the first protrusion 627 and the second protrusion 628 may allow the sealing member 67 to be disposed, and the filter cover 66 may be rotatably disposed inside the upper housing 62.

Meanwhile, a limiting protrusion 629 may be formed on a lower surface of the second protrusion 628. The limiting protrusion 629 may protrude downward at a position corresponding to a limiting groove 6614 formed in the filter cover 66. When the filter cover 66 is mounted inside the upper housing 62, the limiting protrusion 629 may be inserted into the limiting groove 6614. Accordingly, when the upper housing 62 rotates, the limiting protrusion 629 may move along the limiting groove 6614. The limiting protrusion 629 may be movable only within a region of the limiting groove 6614, and the housing 600 may be rotatable by an angle corresponding to the rotation angle of the limiting protrusion 629.

A support protrusion 6211 may be formed below and spaced apart from the second protrusion 628. The support protrusion 6211 may be configured to support the filter cover 66 from below when the filter cover 66 is mounted inside the upper housing 62.

The support protrusion 6211 may protrude from an inner surface of the upper housing 62 and may be formed at a position corresponding to a lower end of the filter cover 66. A pair of support protrusions 6211 may be disposed at positions facing each other. In this case, the pair of support protrusions 6211 may be formed with different sizes to prevent incorrect assembly when the filter cover 66 is coupled.

Meanwhile, due to the characteristic structure in which the housing 600 rotates when the filter 60 is installed, the filter cover 66—namely, the water inlet part 663 and the water outlet part 664—must necessarily be aligned relative to the housing 600 before being coupled with the head 50.

Specifically, when the filter cover 66 is mounted to the upper housing 62, the water inlet part 663 and the water outlet part 664 may be aligned with a specific orientation within the upper housing 62. The user may visually confirm the alignment state of the water inlet part 663 and the water outlet part 664 by means of an alignment portion 6275, thereby easily checking their positioning.

An alignment portion 6275 may be formed on an upper surface of the first protrusion 627 of the filter 60. The alignment portion 6275 may be formed on upper, lower, left, and right sides in directions intersecting each other. The alignment portion 6275 may protrude from or be recessed into the upper surface 6271 of the first protrusion 627 so as to be exposed when the filter is viewed from above. In another example, one or two alignment portions 6275 may be formed on left and right sides with respect to the center of the upper housing 62.

The alignment portion 6275 may extend from an outer end of the first protrusion 627 toward the center of the upper housing 62 and may be arranged at an angle of 90° relative to the center of the upper housing 62.

In addition, the alignment portion 6275 may visualize the alignment state with the water inlet part 663 and the water outlet part 664 according to the rotation of the housing 600. As one example, before the filter 60 is mounted to the head 50, the water inlet part 663 and the water outlet part 664 formed on the filter cover 66 may be positioned on the same straight line as the alignment portions 6275 disposed on the left and right sides.

That is, when the upper surface of the filter 60 is viewed from above before being mounted to the head 50, it may be visually confirmed that the alignment portion 6275, the water inlet part 663, and the water outlet part 664 are located on the same straight line VH. This allows the user to determine that the filter cover 66 is in a normal alignment state and ensures proper coupling with the head 50.

Hereinafter, the filter cover 66 will be described in more detail with reference to the drawings.

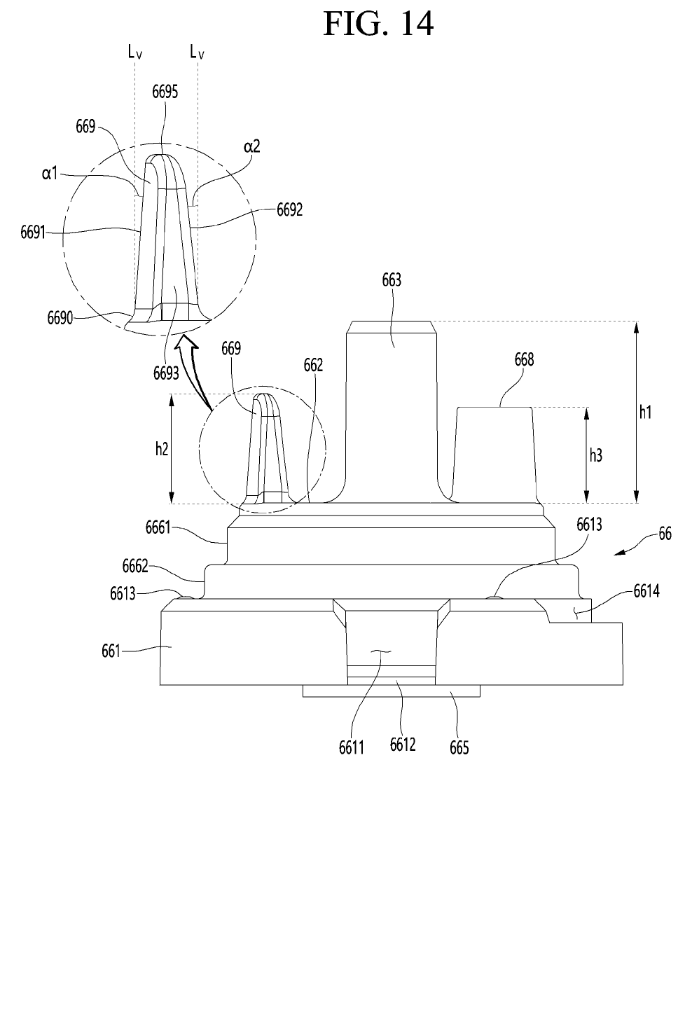

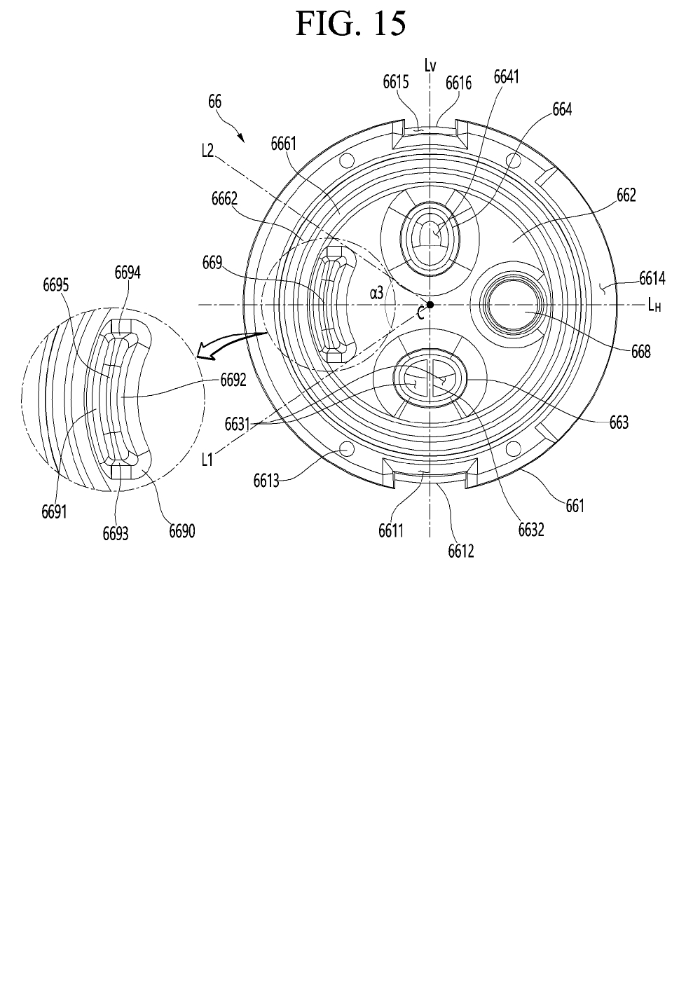

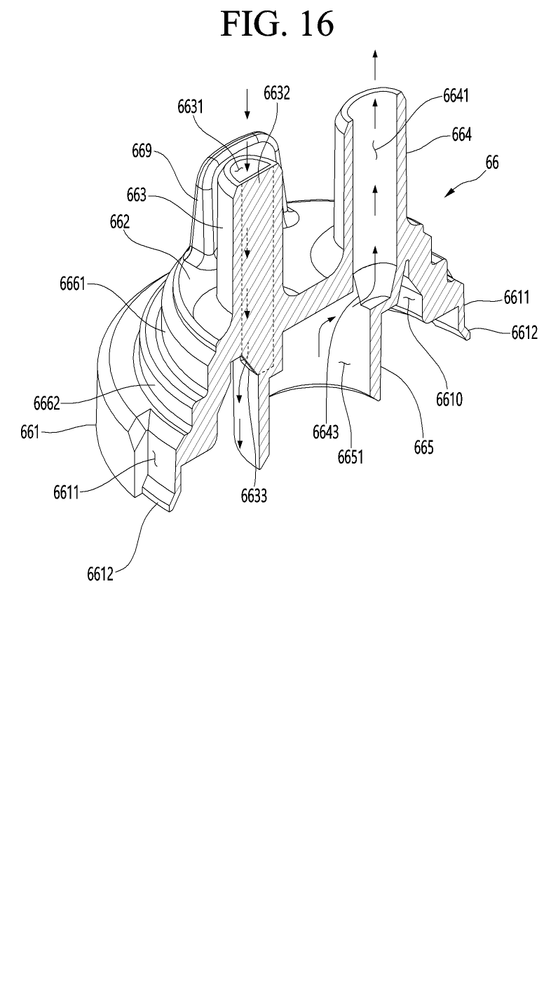

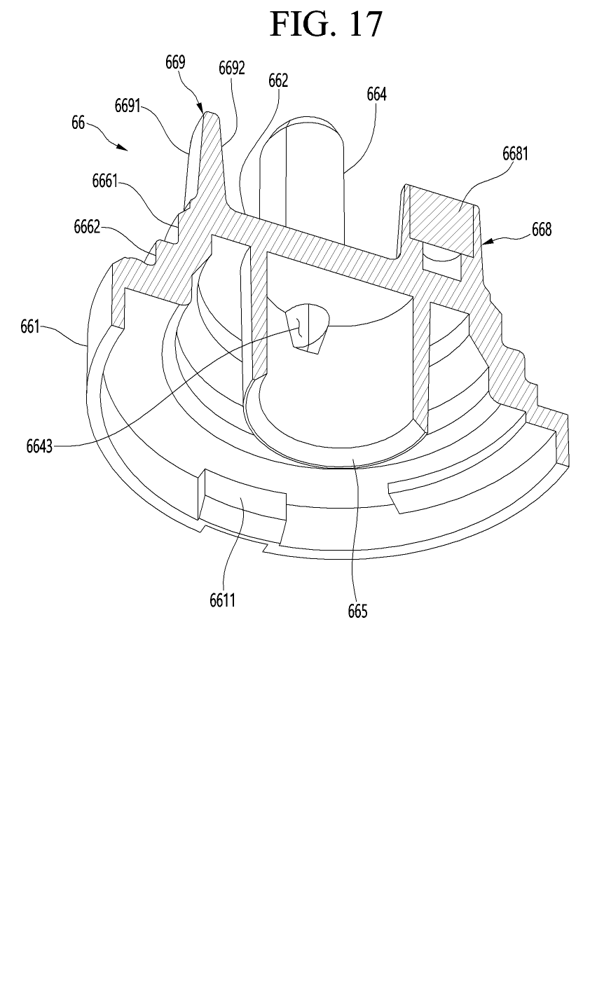

FIG. 13 is a perspective view of the filter cover of the filter as seen from above, and FIG. 14 is a side view of the filter cover, and FIG. 15 is a top view of the filter cover, and FIG. 16 is a cutaway perspective view taken along line 16-16 of FIG. 13, and FIG. 17 is a cutaway perspective view taken along line 17-17 of FIG. 13.

As illustrated, the filter cover 66 may have an open bottom surface and may be formed in a circular shape when viewed from above. A cover rim 661 may be formed at a lower end of the filter cover 66, and the cover rim 661 may contact an inner surface of the upper housing 62.

A pair of rim grooves 6611 and rim hooks 6612 may be formed in the cover rim 661. The rim grooves 6611 may extend from the lower end to the upper end of the cover rim 661. The rim grooves 6611 may be formed at positions corresponding to the support protrusions 6211 and may have a size allowing the support protrusions 6211 to pass through.

In addition, the rim hooks 6612 may be formed at lower ends of the rim grooves 6611. After the support protrusions 6211 pass through the rim grooves 6611 and the rim hooks 6612, they may support the lower end of the filter cover 66. The filter cover 66 may thus remain fixedly mounted to the upper housing 62. During rotation of the housing 600, the support protrusions 6211 may move along the lower end of the cover rim 661.

An stepped portion 6661, 6662 having a smaller diameter than the cover rim 661 may protrude upward from an upper end of the cover rim 661.

Meanwhile, a limiting groove 6614 into which the limiting protrusion 629 is inserted may be formed at an upper end of the cover rim 661. The limiting groove 6614 may be formed between the cover rim 661 and the stepped portion 6662. The limiting groove 6614 may be formed on a surface that contacts a lower surface of the second protrusion 628 when the filter cover 66 is mounted to the upper housing 62.

Accordingly, when the filter cover 66 is inserted upward from below the upper housing 62 and is aligned such that the support protrusions 6211 pass through the rim grooves 6611, the limiting protrusion 629 may be inserted into an inner side of the limiting groove 6614.

One end of the limiting groove 6614 may contact the limiting protrusion 629 when the housing 600 is in a non-rotated state before the filter 60 is installed. The other end of the limiting groove 6614 may contact the limiting protrusion 629 when the housing 600 is in a fully rotated state during installation of the filter 60.

Meanwhile, a plurality of contact protrusions 6613 may be formed on an upper surface of the cover rim 661. The contact protrusions 6613 may be formed along the cover rim 661, for example, three to four contact protrusions 6613 may be spaced apart at regular intervals. The contact protrusions 6613 may contact an inner surface of the upper housing 62. Accordingly, the outer surface of the filter cover 66 and the inner surface of the upper housing 62 may not contact each other entirely but only partially. Thus, the upper housing 62 may rotate with minimized friction against the stationary filter cover 66, ensuring smooth rotational operation.

The stepped portion 666 may be configured in multiple stages and may have a shape corresponding to the protruding and recessed shapes of the inner surface of the upper housing 62. As one example, the stepped portion 666 may include a second stepped portion 6662 at an upper end of the cover rim 661 and a first stepped portion 6661 above the second stepped portion 6662. The sealing member 67 may be seated between the first stepped portion 6661 and the second stepped portion 6662 to hermetically seal a space between the upper housing 62 and the filter cover 66. In addition, the first stepped portion 6661 may close the upper opening 6270 of the first protrusion 627.

An inner upper surface 662, which is exposed through the upper opening 6270, may be formed above the first stepped portion 6661. The inner upper surface 662 may be formed in a circular shape corresponding to the upper opening 6270 and may form the same plane as the upper surface of the first protrusion 627.

The inner upper surface 662 may be provided with the water inlet part 663 and the water outlet part 664, which may also be referred to as an inlet nipple and an outlet nipple, respectively. The water inlet part 663 and the water outlet part 664 may be spaced apart from each other at positions facing each other and may be formed at the same height h1. The inner upper surface 662 may further have the fixing protrusion 669 and the sensing member 668 protruding upward. The fixing protrusion 669 and the sensing member 668 may be arranged in a direction intersecting with the arrangement direction of the water inlet part 663 and the water outlet part 664.

In addition, the water inlet part 663 and the water outlet part 664 may each be formed in an elliptical shape when viewed from above. The water inlet part 663 and the water outlet part 664 may be arranged in mutually different directions when viewed from above. Accordingly, when the filter 60 is mounted to the head 50, the water inlet part 663 and the water outlet part 664 may be coupled to the inlet hole 5321 and the outlet hole 5323 with a defined orientation. In other words, the orientation of the cross-sectional shapes of the water inlet part 663 and the water outlet part 664 may prevent incorrect installation of the filter 60 and ensure proper mounting.

As one example, the water inlet part 663 and the water outlet part 664 may be arranged such that major axes of their respective elliptical cross-sections extend in intersecting directions. That is, the water inlet part 663 may be arranged with its major axis extending in a front-rear direction and its minor axis extending in a left-right direction. In this way, by forming the water inlet part 663 and the water outlet part 664 with elliptical cross-sections and arranging them such that their major axes extend in intersecting directions, the filter cover 66 may be prevented from rotating even when torque is generated during rotation of the housing 600.

The height h2 of the fixing protrusion 669 and the height h3 of the sensing member 668 may be formed lower than the height h1 of the water inlet part 663 and the water outlet part 664. Accordingly, when the filter 60 is mounted to the head 50, the water inlet part 663 and the water outlet part 664 may first be inserted into the inlet hole 5321 and the outlet hole 5323. In other words, because the water inlet part 663 and the water outlet part 664 are formed with a greater height h1, they can be coupled to the head inner 53 without interference from other components 668, 669 during insertion.

In addition, the water inlet part 663, the water outlet part 664, and the fixing protrusion 669 may be sequentially engaged with the head 50. Specifically, even when the housing 600 is further rotated while the water inlet part 663 and the water outlet part 664 are first inserted into the head 50 and the filter cover 66 is held in a fixed state, the filter cover 66 may remain stationary and not rotate. This ensures accurate engagement between the fixing protrusion 669 and the fixing groove 5327.

Specifically, the fixing protrusion 669 may be formed on the cover upper surface 662. The fixing protrusion 669 may engage with the fixing groove 5327 when the filter 60 is mounted to the head 50. Accordingly, the fixing protrusion 669 may provide additional coupling force with the head 50.

The fixing protrusion 669 may also assist in generating torque during rotational operation of the housing 600 and may prevent movement of the water inlet part 663 and the water outlet part 664 during rotation of the housing 600, thereby preventing leakage. Furthermore, the fixing protrusion 669 may prevent loads from being applied to the water inlet part 663 and the water outlet part 664 during rotation of the housing 600, preventing deformation of the water inlet part 663 and the water outlet part 664 and avoiding leakage caused by momentary deformation.

The fixing protrusion 669 may be disposed between the water inlet part 663 and the water outlet part 664 and aligned on the same extension line as the sensing member 668. Both ends of the fixing protrusion 669 may be spaced at equal distances from the center C of the filter cover 66 and may be positioned within a predetermined angular range α3 from the center C of the filter cover 66.

In addition, both ends of the fixing protrusion 669 may be positioned, as seen in FIG. 15, between a tangent L1 passing through a lower end of the water inlet part 663 from the center C of the filter cover 66 and a tangent L2 passing through a lower end of the water outlet part 664 from the center C of the filter cover 66. It should be understood that the tangents L1, L2 may be extension lines that pass through points slightly spaced apart from, rather than in direct contact with, the water inlet part 663 and the water outlet part 664.

Accordingly, the fixing protrusion 669 may reinforce strength to an appropriate level while not interfering with smooth insertion of the water inlet part 663 and the water outlet part 664, nor providing excessive friction or reaction force. As one example, the set angle α3 may be 90° or less.

In addition, a protrusion inclined portion 6690 may be formed at a lower end of the fixing protrusion 669. The protrusion inclined portion 6690 may be formed along the lower circumference of the fixing protrusion 669 and inclined upward. The protrusion inclined portion 6690 may have an inclination corresponding to that of the inclined portion 5328, and thus, when the fixing protrusion 669 is completely inserted into the fixing groove 5327, the protrusion inclined portion 6690 may come into contact with the inclined portion 5328.

The fixing protrusion 669 may be located at an outer edge of the cover upper surface 662. The fixing protrusion 669 may have a rounded shape with a curvature corresponding to the rotational direction of the housing 600. For example, the curvature of an outer surface 6691 of the fixing protrusion 669 may correspond to the curvature of the circumference of the cover upper surface 662. The curvature of the outer surface 6691 of the fixing protrusion 669 may also correspond to the curvature of the upper opening 6270. In other words, the fixing protrusion 669 may be positioned at the outermost location within a range that does not interfere with rotation of the filter cover 66. The fixing protrusion 669 may be positioned on the cover upper surface 662 at a location farthest from the center of the cover upper surface 662. Accordingly, when the housing 600 is rotated for mounting the filter 60, torque generation may be assisted, allowing the housing 600 to be rotated with less force.

The fixing protrusion 669 may include an outer surface 6691 facing outward away from the center of the filter cover 66 and an inner surface 6692 facing toward the center of the filter cover 66. Both the outer surface 6691 and the inner surface 6692 may be formed in a rounded shape. In this case, the inner surface 6692 may be formed with a larger curvature than the outer surface 6691. Accordingly, the fixing protrusion 669 may have higher strength, and particularly, the left and right ends 6693 and 6694 of the fixing protrusion 669 may be thicker than a central portion of the fixing protrusion 669. As a result, breakage of the left and right ends 6693 and 6694 of the fixing protrusion 669, where load is substantially concentrated during rotation of the housing 600, may be prevented, and generation of effective torque may be assisted.

The fixing protrusion 669 may be formed such that its thickness decreases as it extends upward from the bottom. Furthermore, until the fixing protrusion 669 is completely inserted into the fixing groove 5327, frictional force may be minimized.

In detail, the outer surface 6691 may be formed to be inclined by a predetermined angle α1 in a clockwise direction with respect to a vertical reference line Lv based on the cover top surface 662. The inner surface 6692 may be formed to be inclined by a predetermined angle α2 in a clockwise direction with respect to the same vertical reference line Lv. In this case, the inclination of the inner surface 6692 may be formed to be greater than that of the outer surface 6691 (α1 < α2).

Accordingly, smooth insertion of the water inlet part 663 and the water outlet part 664 may be achieved during insertion of the fixing protrusion 669. In addition, since the lower end of the fixing protrusion 669 has the greatest thickness, it may maintain a stable shape without deformation or damage even under the torque generated during rotation of the housing 600.

Meanwhile, the upper end 6695 of the fixing protrusion 669 may be formed parallel to the cover upper surface 662. The fixing protrusion 669 may be formed such that its width becomes narrower as it extends upward. A width W1 at the lower end of the fixing protrusion 669 may be formed greater than a width W2 at the upper end 6695 of the fixing protrusion 669. Accordingly, when insertion of the fixing protrusion 669 into the fixing groove 5327 begins, the contact area between the fixing protrusion 669 and the fixing groove 5327 may be minimized.

Additionally, rounded portions 6696 may be formed on both left and right sides of the upper end 6695 of the fixing protrusion 669. The rounded portions 6696 may be connected to the side ends 6693 and 6694 and may have a rounded shape. Accordingly, when the fixing protrusion 669 is inserted into the fixing groove 5327, the rounded portions 6696 may guide the fixing protrusion 669 to be directed toward the inner side of the fixing groove 5327.

In addition, a sensing member 668 may protrude upward from the upper surface of the filter cover 66. A magnet 6681 may be mounted inside the sensing member 668. The fixing protrusion 669 and the sensing member 668 may be arranged in a direction intersecting with the arrangement direction of the water inlet part 663 and the water outlet part 664.

The filter cover 66 may include a nipple receiving portion 665. The nipple receiving portion 665 may extend downward from the inner upper surface 662 and may be disposed along the centerline of the filter cover 66. The nipple receiving portion 665 may be formed in a cylindrical shape with an open bottom to form a second space 6651 into which the filter nipple 653 is inserted.

The nipple receiving portion 665 may be formed in a shape corresponding to the outer diameter of the nipple sealing 6533. An outer end of the nipple receiving portion 665 may come into contact with a lower end of the water inlet part 663 and a lower end of the water outlet part 664, respectively. By the nipple receiving portion 665, the interior of the filter cover 66 may be partitioned into a first space 6610 into which water flows through the water inlet part 663 and a second space 6651 from which purified water is discharged toward the water outlet part 664.

In detail, the water inlet part 663 may be in communication with the first space 6610. A lower end of the water inlet part 663 may form an inlet outlet 6633 that communicates with the first space 6610.

An inlet contact portion 6632 may be formed inside the water inlet part 663 to partition an internal water inlet flow path 6631 of the water inlet part 663. The inlet contact portion 6632 may extend from an upper end of the water inlet part 663 to the inlet outlet 6633. In addition, the inlet contact portion 6632 may be formed along the minor axis S1 of the elliptical cross-section of the water inlet part 663.

The water outlet part 664 may be in communication with the second space 6651. A lower end of the water outlet part 664 may form an outlet inlet 6643 that communicates with the second space 6651. An outlet flow path 6641 may be formed inside the water outlet part 664. The cross-sectional shape of the outlet flow path 6641 may be formed in an elliptical shape and may be arranged in a direction intersecting with the cross-sectional shape of the water inlet flow path 6631.

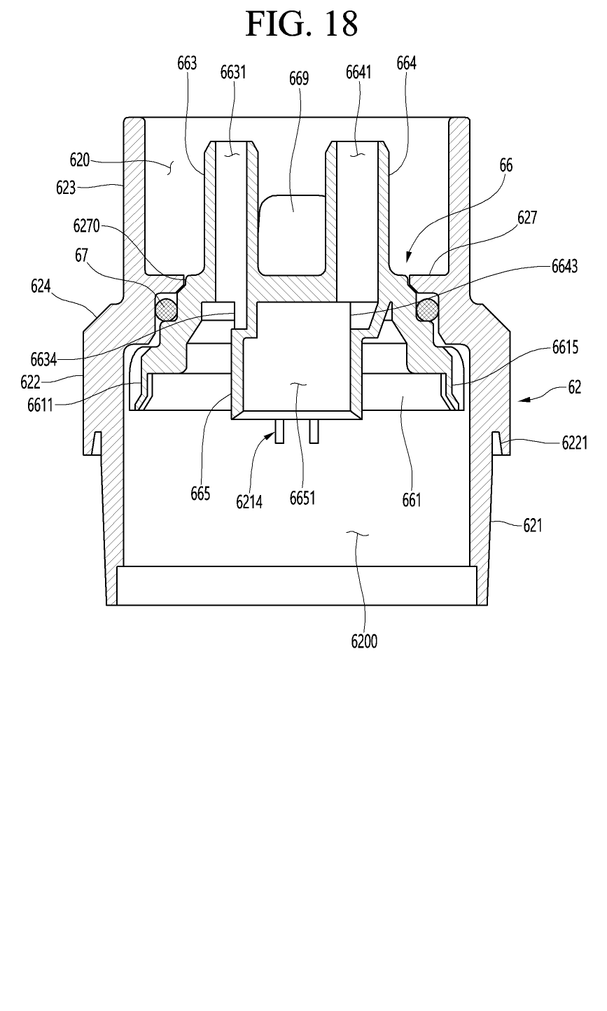

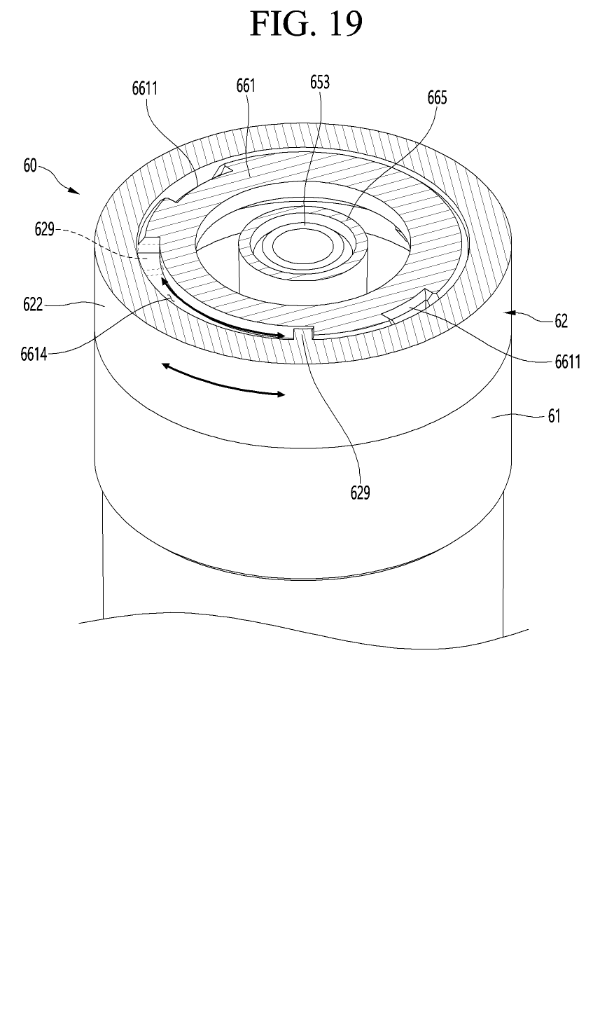

FIG. 18 is a longitudinal sectional view showing the state in which the upper housing and the filter cover are coupled, and FIG. 19 is a view illustrating the state of the fixing protrusion and the fixing groove according to rotation of the housing.

As illustrated, the filter cover 66 may be inserted from the open lower side of the upper housing 62 and mounted so as to shield the upper opening 6270. In a state where the filter cover 66 is mounted to the upper housing 62, the water inlet part 663, the water outlet part 664, the fixing protrusion 669, and the sensing member 668 may be exposed upward through the upper opening 6270.

The filter cover 66 may be supported from below by the support protrusion 6211 in a state where it is inserted into the upper housing 62. Accordingly, the filter cover 66 may remain mounted without being separated from the upper housing 62.

The stepped outer surface of the filter cover 66 and the inner surface of the upper housing 62 may be arranged to correspond to each other. Further, the filter cover 66 and the upper housing 62 may maintain a sealed state while being rotatable relative to each other by means of the sealing member 67.

Meanwhile, when the water inlet part 663 and the water outlet part 664 are in a properly aligned state before the filter 60 is mounted, the restriction protrusion 629 may come into contact with one end of the restriction groove 6614. In other words, when the housing 600 is completely rotated in a counterclockwise direction so that the restriction protrusion 629 and the restriction groove 6614 are in contact with each other and rotation is prevented, the water inlet part 663 and the water outlet part 664 may be in the proper alignment state.

In the process of mounting the filter 60 to the head 50, the filter cover 66 — that is, the water inlet part 663 and the water outlet part 664 — may remain in a stationary state, while the housing 600 may be rotated clockwise relative to the filter cover 66.

When the mounting of the filter 60 to the head 50 is completed, the housing 600 may be rotated by a set angle (approximately 90°) clockwise relative to the filter cover 66. At this time, the first guide protrusion 625 and the second guide protrusion 626 may be arranged in a direction intersecting the arrangement direction of the water inlet part 663 and the water outlet part 664.

When the rotation of the housing 600 is completed and the filter 60 is mounted to the head 50, the restricting protrusion 629 may come into contact with the opposite end of the restricting groove 6614. In other words, the housing 600 may be fully rotated in the clockwise direction and reach a state where it can no longer rotate, allowing the user to recognize that the mounting of the filter 60 is complete.

Hereinafter, the mounting process of the filter 60 having the above-described structure will be described in more detail with reference to the drawings.

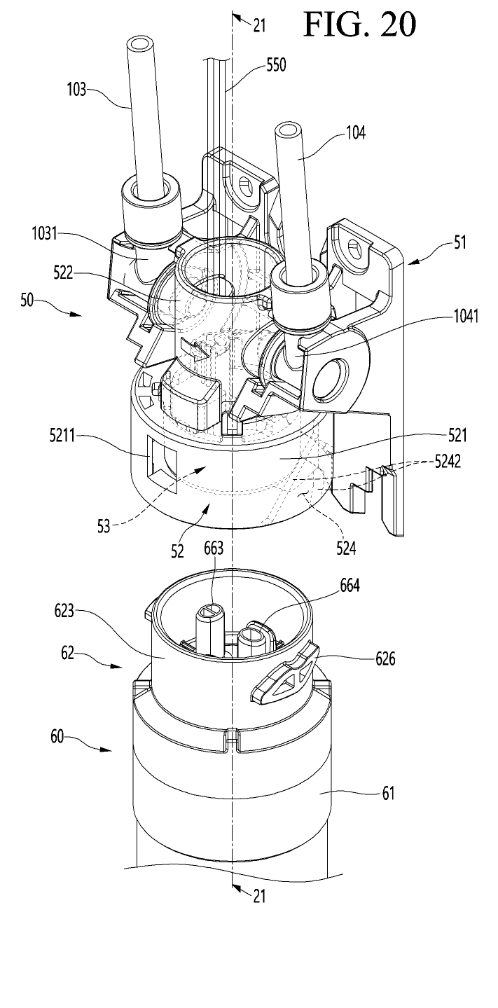

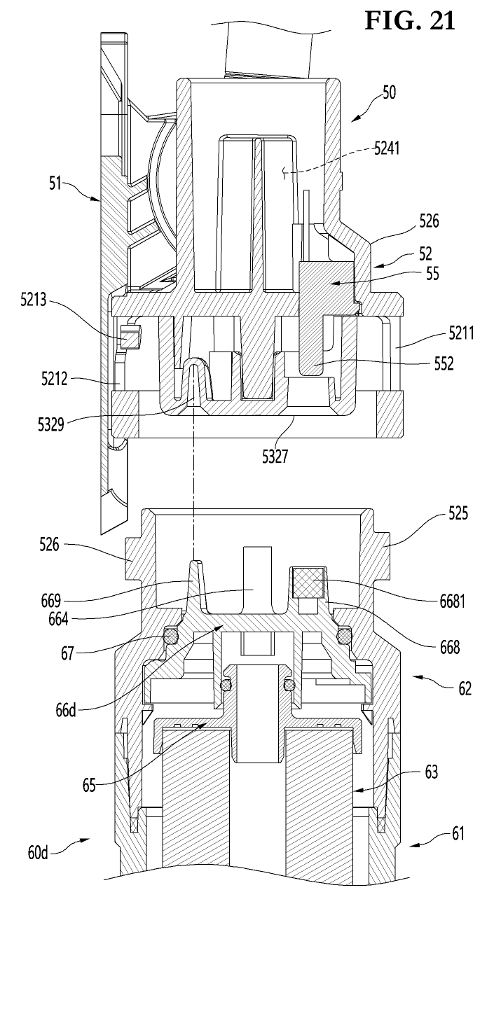

FIG. 20 is an exploded perspective view showing the state in which the filter and the head are separated for coupling of the filter, and FIG. 21 is a cross-sectional view taken along line 21-21 of FIG. 20.

As illustrated, the filter 60 has a structure in which the housing 600 is relatively rotated with respect to the filter cover 66 to be coupled to the head body 52. Therefore, in order to ensure proper installation of the filter 60, it can be confirmed that the water inlet part 663 and water outlet part 664 are aligned between the first guide protrusion 625 and the second guide protrusion 626.

When the filter 60 is in the aligned state, the first guide protrusion 625 and the second guide protrusion 626 may be located on the left and right sides, respectively. To couple the filter 60 to the head, the user may position the first guide protrusion 625 and the second guide protrusion 626 below the first guide hole 5231 and the second guide hole 5241, respectively, which are opened on the lower surface of the head body 52. At this time, the water inlet part 663 and water outlet part 664 of the filter 60, in their aligned state, may be positioned below the inlet hole 5321 and outlet hole 5323.

And, by the alignment of the water inlet part 663 and water outlet part 664, the fixing protrusion 669 and the sensing member 668 may also be naturally aligned. In other words, the fixing protrusion 669 may be positioned vertically below the fixing groove 5329, and the sensing member 668 may be positioned vertically below the sensing hole 5327. The sensing member 668 may be omitted as needed, in which case the fixing protrusion 669 may be positioned vertically below the corresponding fixing groove 5327.

In this aligned state, the filter 60 may be moved upward to begin coupling the filter 60 to the head 50.

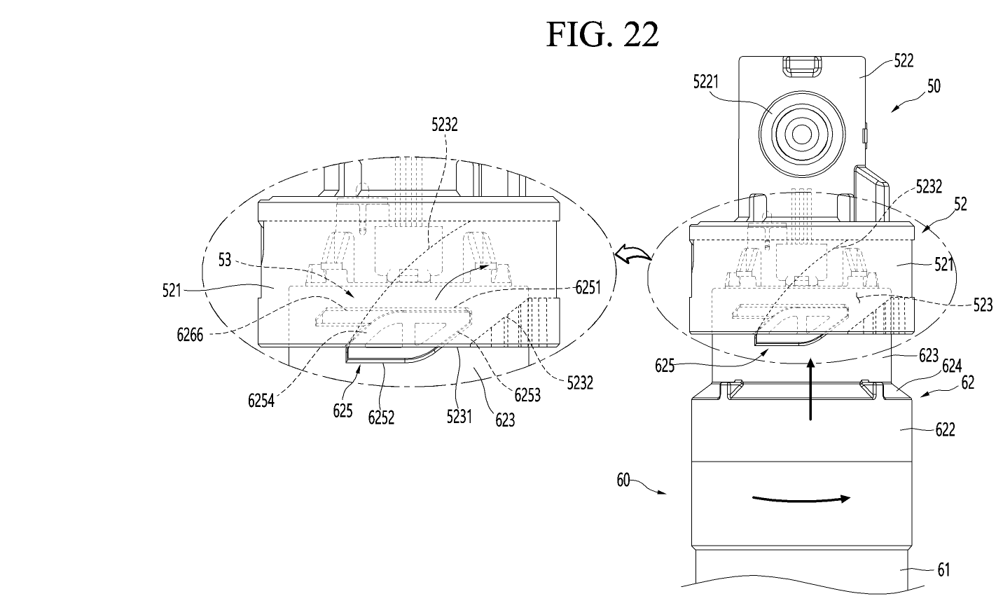

FIG. 22 is a view showing the coupling structure of the guide protrusion and the guide portion when the filter is coupled to the head.

As illustrated, the upper end of the filter 60 may be inserted through the open lower surface of the head body 52. When the filter 60 begins to couple with the head body 52, the first guide protrusion 625 may be inserted into the first guide 523, and the second guide protrusion 626 may be inserted into the second guide 524.

In particular, the first guide protrusion 625 may be structurally prevented from being inserted into the second guide 524, thereby preventing incorrect installation of the filter 60. Furthermore, the cross-sections of the water inlet part 663 and water outlet part 664 are formed to have directionality, so that they can only be inserted into the inlet hole 5321 and outlet hole 5323 when the first guide protrusion 625 is inserted into the first guide 523 and the second guide protrusion 626 is inserted into the second guide 524.

The first guide protrusion 625 and the second guide protrusion 626 may move along the inclined surfaces of the first guide portion 5232 and second guide portion 5242 within the first guide 523 and second guide 524. As the first guide protrusion 625 and the second guide protrusion 626 move along the first guide 523 and the second guide 524, the housing 600 may be rotated in a clockwise direction.

Additionally, the water inlet part 663 and water outlet part 664 may be inserted into the corresponding inlet hole 5321 and outlet hole 5323, respectively. The water inlet part 663 and water outlet part 664 may be inserted into the inlet hole 5321 and outlet hole 5323 at the moment when the first guide protrusion 625 and second guide protrusion 626 are inserted into the first guide 523 and second guide 524.

At this point, since the water inlet part 663 and water outlet part 664 are already in an aligned state, proper installation may be achieved simply by inserting the first guide protrusion 625 and the second guide protrusion 626 into the first guide 523 and the second guide 524 without any additional alignment process.

Meanwhile, during coupling of the filter 60, the water inlet part 663 and water outlet part 664 may be coupled to the head before the fixing protrusion 669 and the sensing member 668. When the water inlet part 663 and water outlet part 664 begin their initial insertion, the fixing protrusion 669 and the sensing member 668 may still remain in a non-inserted state. Accordingly, the water inlet part 663 and water outlet part 664 may begin their insertion without any interference from the fixing protrusion 669 and the sensing member 668, thereby allowing smooth and accurate insertion.

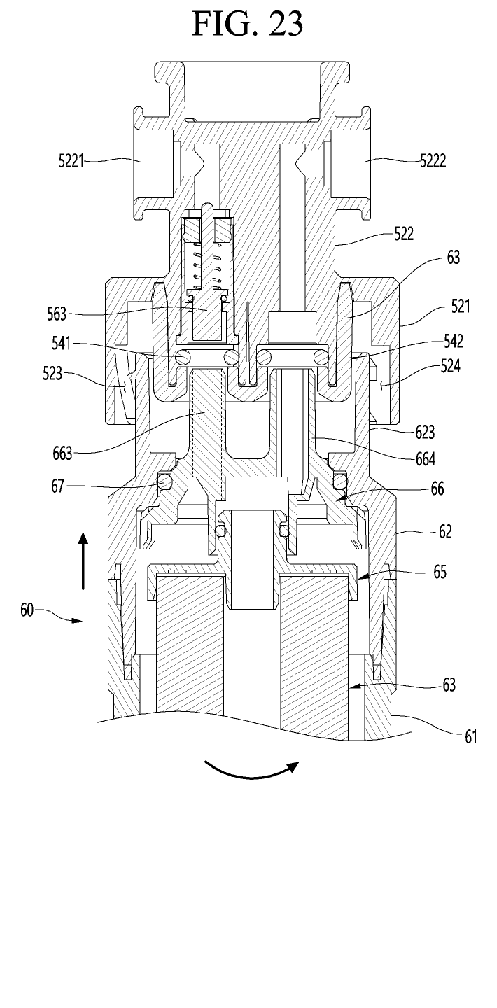

FIG. 23 is a longitudinal sectional view showing the arrangement of the water inlet and the water outlet while the filter is being coupled to the head, and FIG. 24 is a longitudinal sectional view showing the arrangement of the fixing protrusion while the filter is being coupled to the head.

As illustrated, the filter 60 may be rotated while inserted into the head 50 to complete coupling with the head 50. In this process, the housing 600 may rotate relative to the filter cover 66 while moving upward, and the filter cover 66 may also move upward while being engaged with the head inner 53.

Specifically, as the housing 600 is rotated, the first guide protrusion 625 and the second guide protrusion 626 may move upward along the first guide 523 and the second guide 524, respectively. The water inlet part 663 and the water outlet part 664 may further move upward while passing through the inlet ring 541 and the outlet ring 542, respectively. Accordingly, the water inlet part 663 and water outlet part 664 may be in a sealed state inside the inlet hole 5321 and the outlet hole 5323.

And the housing 600 may be further moved upward as the first guide protrusion 625 and the second guide protrusion 626 travel along the first guide 523 and the second guide 524. The water inlet part 663 and the water outlet part 664 may be inserted further such that the end of the water inlet part 663 comes into contact with the valve 56, thereby starting to open the valve 56.

In addition, the fixing protrusion 669 and the sensing member 668 may also be further inserted into the fixing groove 5329 and the sensing hole 5237, respectively.

At this time, the fixing protrusion 669 may begin to be inserted into the inside of the fixing groove 5329 and may proceed into the inside of the fixing groove 5327. When the fixing protrusion 669 is initially inserted, it may not contact the fixing groove 5327. Accordingly, the fixing protrusion 669 does not resist the insertion of the water inlet part 663 and the water outlet part 664 during its insertion into the fixing groove 5327, thereby ensuring smooth insertion and mounting of the water inlet part 663 and the water outlet part 664.

When the insertion of the fixing protrusion 669 has progressed, both side ends of the fixing protrusion 669 may contact the inner surface of the fixing groove 5327 and be constrained. Therefore, during the rotation of the housing 600, the filter cover 66 may remain in a stationary state, preventing movement of the water inlet part 663 and the water outlet part 664.

Accordingly, the torque generated during the rotation of the housing 600 may not be transmitted to the water inlet part 663 and the water outlet part 664, thereby ensuring stable rotation of the housing 600.

In addition, the housing 600 may be moved further upward as the first guide protrusion 625 and the second guide protrusion 626 move along the first guide 523 and the second guide 524. The water inlet part 663 and the water outlet part 664 may be further inserted such that the end of the water inlet part 663 comes into contact with the valve 56, thereby initiating the opening of the valve 56.

Furthermore, the sensing member 668 may continue to be inserted into the inside of the sensing hole 5327. As the sensing member 668 is inserted, it may gradually approach the filter sensing device 55 and come within the detectable range of the filter sensing device 55.

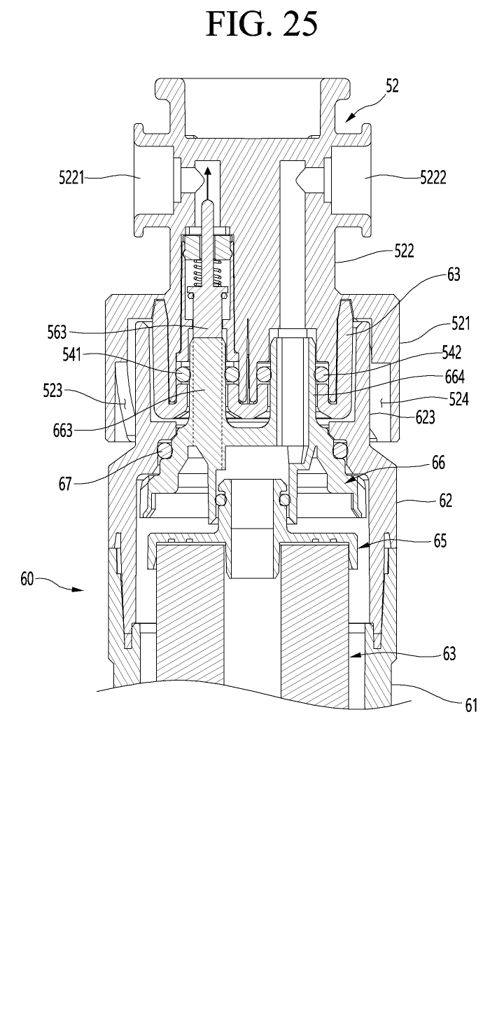

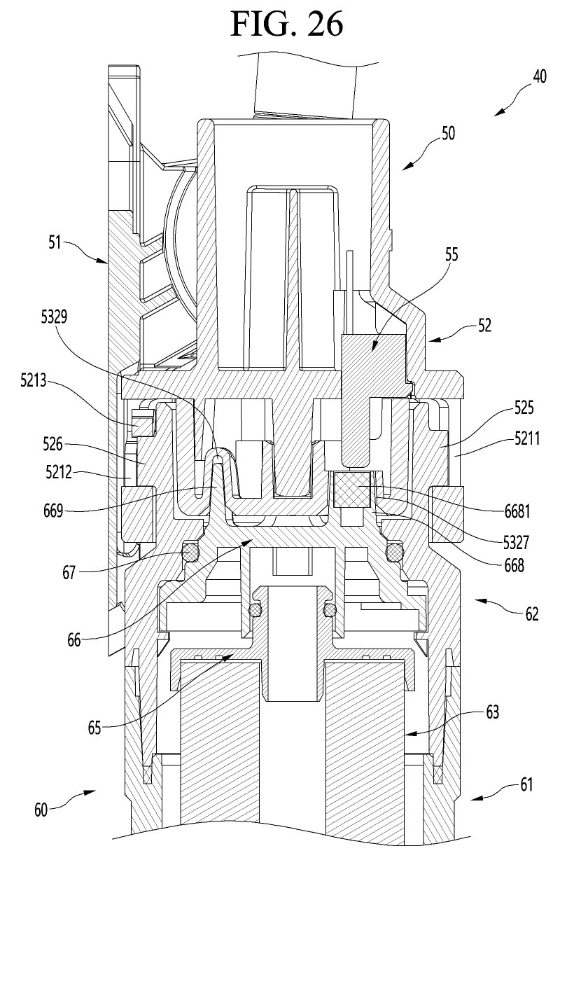

FIG. 25 is a longitudinal sectional view showing the arrangement of the water inlet and the water outlet when the filter is completely coupled to the head, and FIG. 26 is a longitudinal sectional view showing the arrangement of the fixing protrusion when the filter is completely coupled to the head.

As illustrated, when the filter 60 is fully coupled to the head body 52, the first guide protrusion 625 and the second guide protrusion 626 may move laterally at the upper ends of the first guide 523 and the second guide 524 and remain in a fixed state.

At this time, the first guide protrusion 625 may be positioned within the check window 5211. The check window 5211 may be opened toward the front, and the first guide protrusion 625 may be exposed forward through the check window 5211. Accordingly, a user may visually confirm that the connecting rib 6255 is positioned at the center of the check window 5211, thereby confirming that the filter 60 has been completely mounted to the head 50.

In detail, at the moment when the filter 60 is completely coupled to the head body 52, the restriction groove 6266 may be latched with the restriction portion 5213 formed on the head 50 (see FIG. 24). The user may determine that the filter 60 has been properly coupled to the head 50 by recognizing the clicking sound or vibration generated at this time.

In addition, in the state where the filter 60 is completely mounted, the restriction protrusion 629 may come into contact with the other end of the restriction groove 6614. Accordingly, when the user rotates the housing 600 in the clockwise direction during the rotational operation until the housing 600 can no longer rotate, the user may determine that the filter 60 has been completely mounted to the head 50.

And, when the water inlet part 663 and the water outlet part 664 are completely inserted into the inlet hole 5321 and the outlet hole 5323, respectively, the inside of the filter 60 may be in fluid communication with the inlet flow path 5241 and the outlet flow path 5251 of the head 50. When the installation of the filter 60 is completed, the valve 56 and the water supply valve 102 may be opened, allowing water to be supplied to the filter 60 for purification.

The fixing protrusion 669 may be completely inserted into the fixing groove 5327, and the outer surface of the fixing protrusion 669 may come into close contact with the inner surface of the fixing groove 5327. Accordingly, by the engagement between the fixing protrusion 669 and the fixing groove 5327, the filter 60 may be more securely coupled to the head 50. Even if an external impact is applied to the housing 600, the filter cover 66 can maintain its fixed state, thereby preventing the water inlet part 663 and the water outlet part 664 from moving.

When the sensing member 668 is fully inserted into the sensing hole 5237, the filter sensing device 55 may detect this and open the water supply valve 102, thereby initiating water supply toward the filter 60.

Hereinafter, the water flow state of the filter assembly 40 with the filter 60 coupled will be described in greater detail with reference to the drawings.

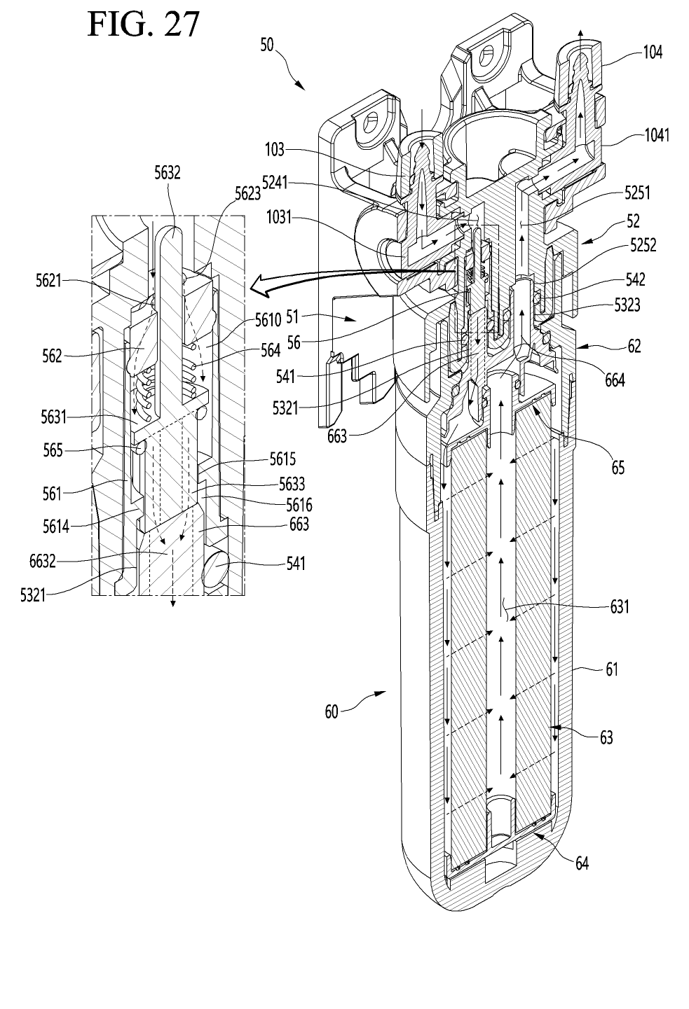

FIG. 27 is a view illustrating water flow when the filter is completely coupled to the head.

As illustrated, when the filter 60 is fully coupled to the head 50, the water inlet 663 and the water outlet 664 may be inserted into the inlet hole 5321 and outlet hole 5323, respectively.

The upper end of the water inlet part 663 may then come into contact with the contact portion 5633, thereby pushing the piston 563 upward to open the case passage 5615. With the water supply valve 102 open, water supplied through the inlet passage 5241 may flow through the cap through-hole 5623 and into the piston accommodating portion 5610.

When the piston 563 is moved upward, water may flow through the flow path space S, pass through the case passage 5615, and flow into the inlet accommodating portion 5616. The water introduced into the inlet accommodating portion 5616 may then be supplied to the inside of the filter 60 through the inlet flow path 6631 of the inlet 663 inserted into the inlet accommodating portion 5616.

Accordingly, water introduced through the inlet pipe 103 may flow through the inlet passage 5241 of the head 50, the valve 56, and the inlet flow path 6631, and be introduced into the interior of the filter 60. The introduced flow may be guided to the outer side of the filter member 63 through the first space 6610. Water on the outer side of the filter member 63 may pass through the filter member 63 and move into the hollow portion 631. During this process, the water may be purified. The purified water may flow upward through the hollow portion 631 toward the second space 6651 and may be discharged through the outlet 664.

Then, the purified water of the filter 60 may flow through the outlet 664 into the outlet passage 5251 and be discharged to the outside through the outlet pipe 104.

While water flows through the filter 60, the peripheries of the water inlet part 663 and water outlet part 664 may be sealed by the inlet ring 541 and the outlet ring 542, respectively, thereby preventing leakage.

The filter 60 may be detached from the head 50 after purifying water for a predetermined period or a preset amount of water and then replaced with a new filter 60. In order to detach the filter 60 from the head 50, the housing 600 is rotated and moved downward in the reverse order of the process described above. During this reverse rotation of the filter 60, the water inlet part 663 and water outlet part 664 move downward and are disengaged from the inlet hole 5321 and the outlet hole 5323. Then, the valve 56 is closed again by the downward movement and separation of the water inlet part 663, thereby preventing water introduced through the inlet pipe 103 from leaking to the outside of the head 50.

Meanwhile, in addition to the embodiment described above, various other embodiments of the present invention are also possible. Hereinafter, another embodiment of the present invention will be described with reference to the drawings. For the components of the other embodiment that are identical to those of the previous embodiment, detailed descriptions and illustrations may be omitted, and the same reference numerals may be used for explanation.

That is, only the structures different from those of the previous embodiment will be described hereinafter, and the other components that are not described may be the same as those of the previous embodiment. Accordingly, components that are not illustrated or not described in detail may be referred to in the drawings of the previous embodiments.

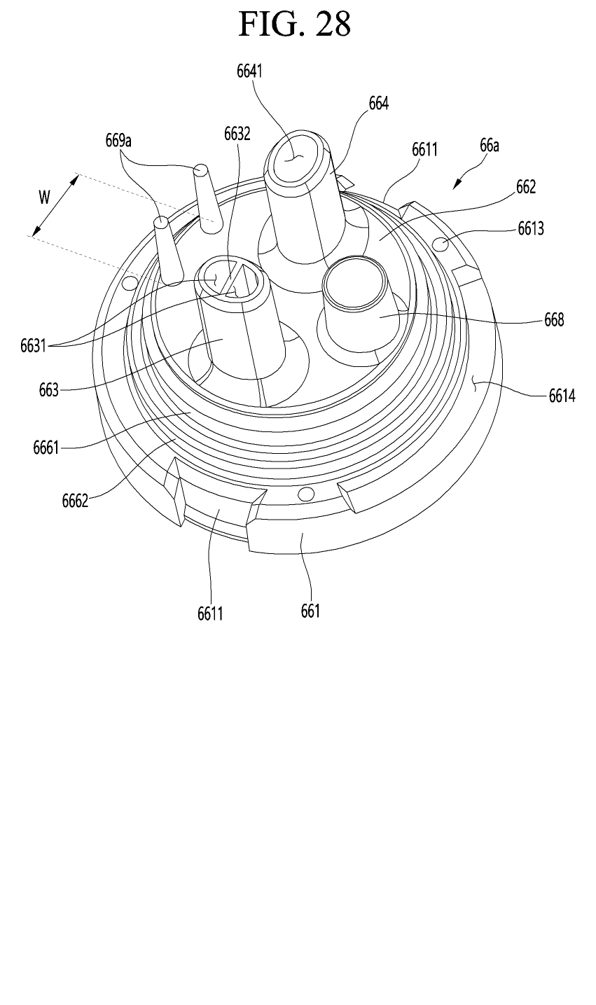

FIG. 28 is a perspective view of the filter cover according to a second embodiment of the present disclosure.

As illustrated, the filter assembly 40 according to the second embodiment of the present invention may include the head 50 and the filter 60. The filter 60 may be configured to be detachably coupled to the head 50. Compared to the previous embodiment, only the shape of the fixing protrusion 669a formed on the filter cover 66a is different, while the remaining components may be the same.

The housing 600 of the filter 60 may be provided with the filter cover 66a so as to be rotatable. The filter cover 66a may shield the upper opening 6270 of the upper housing 62 and have its upper surface exposed through the upper opening 6270.

The filter cover 66a may include an inner rim 661 forming its circumference and stepped portions 6661 and 6662 formed on the upper surface of the inner rim 661 with a smaller diameter than the inner rim 661. An inner upper surface 662 may be formed on top of the stepped portions 6661 and 6662.

Grooves 6611 and rim hooks 6612 may be formed on the outer circumferential surface of the inner rim 661, allowing the filter cover 66a to be rotatably mounted inside the housing 600.

The water inlet part 663 and the water outlet part 664 may be formed on the upper surface of the filter cover 66a. The water inlet part 663 and water outlet part 664 may each have an elliptical cross-sectional shape, and they may be arranged so that the major axes face different directions. The interior of the water inlet part 663 may be partitioned by the inlet contact portion 6632.

A sensing member 668 may be formed on the upper surface of the filter cover 66a. The sensing member 668 may protrude upward and be insertable into a sensing hole 5327 formed in the head 50.

A fixing protrusion 669a may further be provided on the upper surface of the filter cover 66a. The fixing protrusion 669a may protrude upward and be insertable into a fixing groove 5329 formed in the head 50.

The fixing protrusion 669a may include a pair of protrusions spaced apart from each other. In this case, the pair of fixing protrusions 669a may be formed at positions corresponding to both ends of the fixing groove 5329.

Specifically, the pair of fixing protrusions 669a may be formed in the same shape. For example, the fixing protrusions 669a may be formed in a cylindrical shape, with their diameter gradually decreasing toward the top. The outer surfaces of the fixing protrusions 669a may closely contact the inner surface of the fixing groove 5329, particularly the rounded inner surfaces at both ends of the fixing groove 5329. The height of the fixing protrusions 669a may be lower than the height of the water inlet part 663 and the water outlet part 664, but higher than the height of the sensing member 668.

Furthermore, the width (W) between the outer surfaces of the pair of fixing protrusions 669a may correspond to the width of the opening of the fixing groove 5329. Accordingly, when the fixing protrusions 669a are fully inserted into the fixing groove 5329, the pair of fixing protrusions 669a may support both ends of the fixing groove 5329.

The fixing protrusions 669a may be inserted into the fixing groove 5329 when the filter 60 is inserted. The fixing protrusions 669a may be inserted into the fixing groove 5329 after the insertion of the water inlet part 663 and the water outlet part 664 has begun.

The fixing protrusions 669a may be positioned between the water inlet part 663 and the water outlet part 664. The fixing protrusions 669a may be located opposite to the sensing member 668 and aligned on an extension line passing through the center of the filter cover 66a.

The fixing protrusions 669a may be located at the edge of the cover upper surface 662. The pair of fixing protrusions 669a may each be positioned at an equal distance from the water inlet part 663 and the water outlet part 664.

When the housing 600 is rotated, the filter cover 66a can remain in a fixed state by means of the engagement between the fixing protrusions 669a and the fixing groove 5329, allowing only the housing 600 to rotate. Additionally, even when torque is generated by the rotation of the housing 600, torque is prevented from being transmitted to the water inlet part 663 and water outlet part 664, thereby preventing their movement and eliminating the possibility of leakage.

In another example, at least a part of the pair of fixing protrusions 669a may be connected to each other. In yet another example, the fixing protrusion 669a may be formed as a single protrusion. In this case, the fixing protrusion 669a may be positioned to contact one end of the fixing groove 5329, specifically the end corresponding to the rotational direction of the filter 60 during installation.

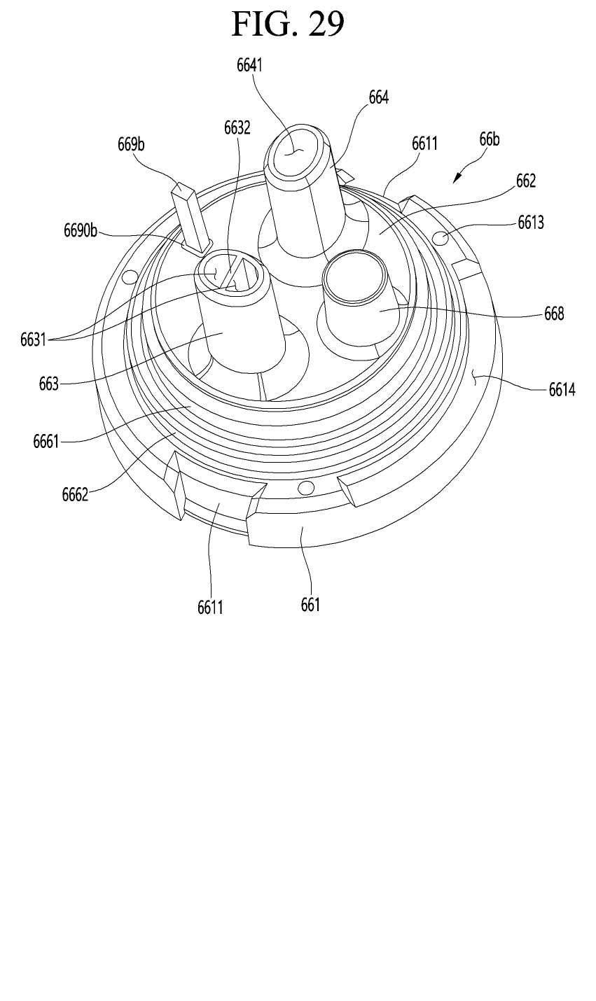

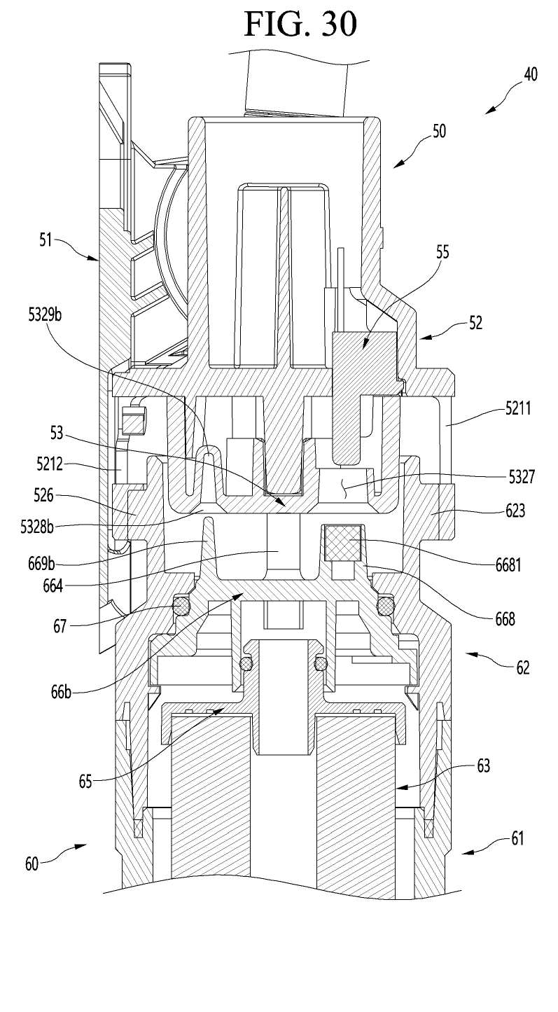

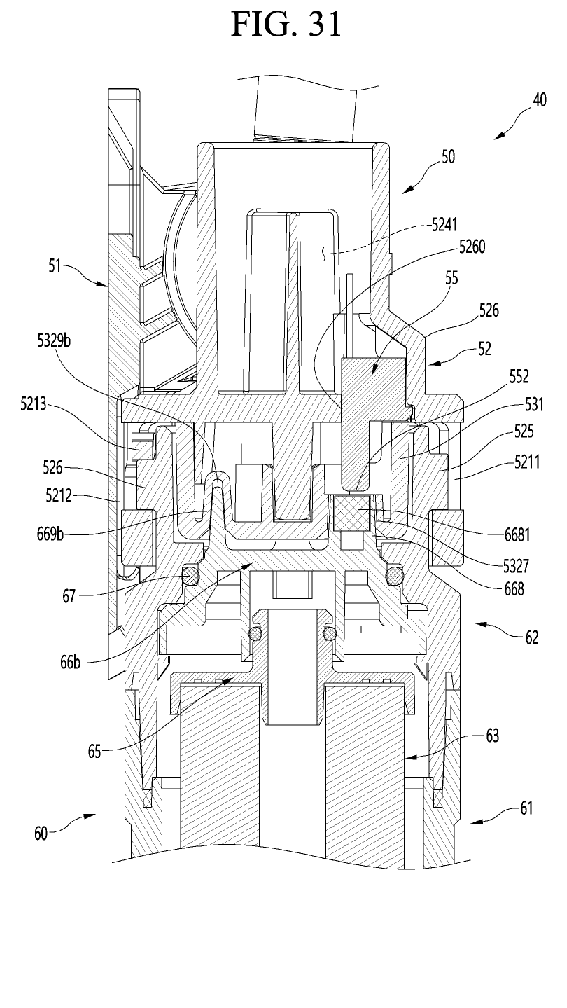

FIG. 29 is a perspective view of the filter cover according to a third embodiment of the present disclosure, and FIG. 30 is a longitudinal sectional view showing the state in which the filter and the head are being coupled according to the third embodiment of the present disclosure, and FIG. 31 is a longitudinal sectional view showing the state in which the coupling of the filter and the head is completed.

As illustrated, the filter assembly 40 according to the third embodiment may include the head 50 and the filter 60. The filter 60 may be configured to be detachably coupled to the head 50. Compared with the previously described embodiments, only the shape of the fixing protrusion 669b formed on the filter cover 66b is different, while the other components may be the same.

The filter 60 may include a housing 600 in which the filter cover 66b is rotatably provided. The filter cover 66b may shield the upper opening 6270 of the upper housing 62, with its upper surface being exposed through the upper opening 6270.

The filter cover 66b may include an inner rim 661 forming its circumference, and a stepped portion 6661, 6662 formed on the upper surface of the inner rim 661 with a diameter smaller than that of the inner rim 661. An inner upper surface 662 may be formed at the upper end of the stepped portion 6661, 6662.

On the outer circumferential surface of the inner rim 661, a rim groove 6611 and a rim hook 6612 may be formed, allowing the filter cover 66b to be rotatably mounted inside the housing 600.

On the upper surface of the filter cover 66b, the water inlet part 663 and water outlet part 664 may be formed. The water inlet part 663 and the water outlet part 664 may have an elliptical cross-sectional shape. The major axes of the water inlet part 663 and the water outlet part 664 may be oriented in different directions. The interior of the water inlet part 663 may be partitioned by the inlet contact portion 6632.

A sensing member 668 may be formed on the upper surface of the filter cover 66b. The sensing member 668 may protrude upward and be inserted into a sensing hole 5327 formed in the head 50.

A fixing protrusion 669b may further be provided on the upper surface of the filter cover 66b. The fixing protrusion 669b may protrude upward and be inserted into a fixing groove 5328b formed in the head 50. The fixing groove 5328b may be formed above, corresponding to the fixing protrusion 669b, and may be shaped to allow insertion of the fixing protrusion 669b. The fixing groove 5328b may have the same shape as the fixing groove described in the previous embodiment.

The fixing protrusion 669b may be formed as a single protrusion or rib shape. The fixing protrusion may be formed to protrude upward from the upper surface of the cover. In this case, the height of the fixing protrusion 669b may be formed lower than the height of the water inlet part 663 and the water outlet part 664. In addition, the height of the fixing protrusion 669b may be formed higher than the height of the sensing member 668.

The fixing protrusion 669b may be formed in a shape that allows insertion into the fixing groove 5328b and may be shaped to contact one inner end of the fixing groove 5328b when the housing 600 is rotated. For example, when viewed from above, the fixing protrusion 669b may have a rectangular cross-sectional shape. Of course, the edges of the fixing protrusion 669b may be formed in a rounded or inclined shape. When the filter 60 is assembled, the fixing protrusion 669b may be completely inserted into the inside of the fixing groove 5328b.

The fixing protrusion 669b may be located between the water inlet part 663 and water outlet part 664. In addition, the fixing protrusion 669b may be positioned to face the sensing member 668. The fixing protrusion 669b and the sensing member 668 may be arranged along an extension line passing through the center of the filter cover 66b.

Specifically, the fixing protrusion 669b may extend in a direction away from the center of the filter cover 66b. The fixing protrusion 669b may have a uniform thickness along the extending direction. The thickness of the fixing protrusion 669b may also be formed to gradually decrease as it extends upward. The extending length of the fixing protrusion 669b may have a length suitable for insertion into the fixing groove 5328b.

One end of the fixing protrusion 669b may be positioned at a location spaced apart from the center of the filter cover 66b, and the other end, i.e., the extended end of the fixing protrusion 669b, may be located at the outer edge of the cover top surface 662.

An inclined protrusion slope 6690b may be formed at the lower end of the fixing protrusion 669b. The protrusion slope 6690b may have an inclination corresponding to the circumference of the open lower surface of the fixing groove 5328b.

When the housing 600 is rotated, the filter cover 66b may remain fixed due to the engagement between the fixing protrusion 669b and the fixing groove 5328b, allowing only the housing 600 to rotate.

The outer surface of the fixing protrusion 669b may be formed as a flat surface, thereby effectively supporting torque generated during the rotation of the housing. In addition, the fixing protrusion 669b may remain in contact with one inner surface end of the fixing groove 5328b during the rotation of the housing 600. Accordingly, torque generated during the rotation of the housing 600 may not be transmitted to the water inlet part 663 and water outlet part 664, preventing movement of the water inlet part 663 and water outlet part 664 and avoiding leakage.

According to an embodiment of the present disclosure, the water filter and the home appliance equipped with the water filter have the following advantageous effects.

According to an embodiment of the present disclosure, when the housing is rotated for attaching or detaching the filter, the fixing protrusion is inserted into the fixing groove and maintained in a fixed state, thereby preventing flow between the water inlet and the water outlet even during rotation of the housing. Accordingly, there is an advantage in that leakage can be prevented during attachment and detachment of the filter.

Furthermore, according to an embodiment of the present disclosure, the engagement between the fixing protrusion and the fixing groove can assist in generating torque for rotating the housing, thereby facilitating rotation of the housing. Accordingly, there is an advantage in that the housing can be rotated with less force, thereby improving the convenience of filter replacement.

In addition, according to an embodiment of the present disclosure, even if excessive force is applied during the rotation of the housing, additional fixing force generated by the engagement between the fixing protrusion and the fixing groove can prevent deformation or breakage of the water inlet and the water outlet. In particular, even when excessive load is applied due to incorrect operation during the attachment or detachment process of the filter, damage to the filter can be prevented.

What is claimed is:

1. A water filter detachably coupled to a head connected to a water supply source comprising:
a housing having an upper opening formed at an upper portion thereof, and configured to be coupled to the head by rotation;
a filter cover provided inside the housing to cover the upper opening and including a water inlet part protruding upward through which water flows in, and a water outlet part through which water flows out; and
a filter member disposed inside the housing and connected to the filter cover to purify water,
wherein the filter cover includes a fixing protrusion protruding upward to be inserted into the head and the fixing protrusion is configured to keep the filter cover fixed state when the housing rotates.

2. The water filter according to claim 1,
wherein the water inlet part and the water outlet part protrude from the filter cover at positions spaced apart from each other with respect to a center of the filter cover.

3. The water filter according to claim 2,
wherein the fixing protrusion is formed between the water inlet part and water outlet part.

4. The water filter according to claim 3,
wherein the fixing protrusion is positioned at an equal distance from the water inlet part and water outlet part.

5. The water filter according to claim 3,
wherein the fixing protrusion is disposed between tangents passing through the water inlet part and water outlet part from the center of the filter cover.

6. The water filter according to claim 1,
wherein the fixing protrusion comprises a pair of the fixing protrusion,
and a width between the pair of fixing protrusions corresponds to an opening size of a fixing groove formed in the head.

7. The water filter according to claim 1,
wherein the fixing protrusion is formed with a rounded shape in a direction corresponding to a rotational direction of the housing.

8. The water filter according to claim 1,
wherein a protrusion is formed to protrude toward a center of the housing along an opened inner surface of the housing and defines the upper opening,
and the filter cover is mounted below the protrusion such that the water inlet part, the water outlet part, and the fixing protrusion pass through the upper opening.

9. The water filter according to claim 8,
wherein the fixing protrusion is formed to extend along the upper opening.

10. The water filter according to claim 9,
wherein the fixing protrusion is formed with a curvature corresponding to the upper opening.

11. The water filter according to claim 1,
wherein the filter cover includes a cover upper surface exposed through the upper opening, and
the fixing protrusion is formed along an edge of the cover upper surface.

12. The water filter according to claim 1,
wherein the fixing protrusion is formed such that a thickness thereof becomes thinner as the fixing protrusion extends upward from the filter cover.

13. The water filter according to claim 12,
wherein the fixing protrusion includes an inner surface facing a center direction of the filter cover and an outer surface facing a direction opposite to the inner surface, and
an inclination angle of the inner surface with respect to a vertical extension line from the filter cover is greater than an inclination angle of the outer surface.

14. The water filter according to claim 13,
wherein left and right end portions of the fixing protrusion are formed to become closer to each other as they extend upward from the filter cover.

15. The water filter according to claim 14,
wherein an upper end of the fixing protrusion is formed to be parallel with an upper surface of the filter cover, and
rounded portions are formed on left and right sides of the fixing protrusion, the rounded portions being connected to the left and right end portions and having a rounded shape.

16. The water filter according to claim 1,
wherein the fixing protrusion is formed to have a height lower than that of the water inlet part and the water outlet part, and
when the filter is coupled to the head, the fixing protrusion and the water inlet part and water outlet part are sequentially inserted into the head.

17. The water filter according to claim 1,
wherein the water inlet part and the water outlet part are disposed on a horizontal extension line passing through a center of the filter cover, and
the fixing protrusion is disposed on a vertical extension line passing through the center of the filter cover and intersecting the horizontal extension line perpendicularly.

18. The water filter according to claim 1,
wherein a sensing member for recognizing the filter protrudes upward from the filter cover, and
the sensing member is recognized by a filter sensing device provided in the head when the filter is coupled.

19. The water filter according to claim 18,
wherein the fixing protrusion is formed to be lower than the water inlet part and the water outlet part, and higher than the sensing member.

20. An appliance comprising:
a cabinet;
a head disposed in the cabinet and connected to a water supply source; and
a water filter detachably coupled to the head,
wherein the water filter comprises:
a housing having an upper opening formed therein and configured to be coupled to the head by rotation;
a filter cover provided inside the housing to cover the upper opening, and including a water inlet part protruding upward through which water is introduced and a water outlet part through which water is discharged; and
a filter member provided inside the housing and connected to the filter cover for purifying water,
wherein the filter cover includes a fixing protrusion protruding upward to be inserted into the head and the fixing protrusion is configured to keep the filter cover fixed state when the housing rotates.
